(19) United States
(12) Patent Application Publication
(10) Pub. No.: US 2023/0325706 A1
(43) Pub. Date: Oct. 12, 2023

(54) ADAPTIVE SENSING AND SENSOR RECONFIGURATION IN PERCEPTIVE WIRELESS COMMUNICATIONS

(71) Applicant: QUALCOMM Incorporated, San Diego, CA (US)

(72) Inventors: Himaja KESAVAREDDIGARI, Bridgewater, NJ (US); Kyle Chi Guan, New York, NY (US); Qing Li, Princeton Junction, NJ (US); Kapil Gulati, Belle Mead, NJ (US); Junyi Li, Fairless Hills, PA (US); Hong Cheng, Basking Ridge, NJ (US)

(21) Appl. No.: 17/714,946

(22) Filed: Apr. 6, 2022

(51) Int. Cl. G06N 20/00; H04W 24/02; G06N 5/04

(52) U.S. Cl. CPC G06N 20/00; H04W 24/02; G06N 5/04; H04W 84/18

(57) ABSTRACT

Aspects are provided which allow a UE to switch between feature data extraction models in order to provide adaptive feature data of dynamic, potential LOS obstacles for improved beam blockage prediction performance (or other functions) at the network node. Initially, the network node receives first feature data from a UE based on a first data extraction model of the UE. The network node transmits a message instructing the UE to switch from the first data extraction model to a second data extraction model of the UE based on a state of the UE. In response to the message, the UE determines to switch from the first data extraction model to the second data extraction model and transmits, to the network node, second feature data based on the second data extraction model. The network node may then determine a beam blockage prediction in response to the second feature data.

### BACKGROUND

### Technical Field

The present disclosure generally relates to communication systems, and more particularly, to adaptive machine learning (ML) and sensor-based inference extraction for dynamic beam interference management.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The invention is defined by the claims. Embodiments and aspects that do not fall within the scope of the claims are merely examples used for explanation of the invention.

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method for wireless communication, a computer-readable medium, and an apparatus are provided. The apparatus may be a user equipment (UE). The apparatus includes a processor; memory coupled with the processor; and instructions stored in the memory and operable, when executed by the processor, to cause the apparatus to: receive a message instructing the apparatus to switch from a current ML-based feature data extraction model to one of a plurality of ML-based feature data extraction models of the apparatus based on a state of the apparatus, the plurality of ML-based feature data extraction models each providing ML-based feature data for predicting a beam blockage between the apparatus and a network entity; determine to switch from the current ML-based feature data extraction model to the one of the ML-based feature data extraction models based at least in part on the message; and transmit, in response to the switch, the ML-based feature data for predicting the beam blockage based on the one of the ML-based feature data extraction models.

In an aspect of the disclosure, an apparatus is provided. The apparatus may be a user equipment (UE). The UE may include means for receiving a message instructing the apparatus to switch from a current ML-based feature data extraction model to one of a plurality of ML-based feature data extraction models of the apparatus based on a state of the apparatus, the plurality of ML-based feature data extraction models each providing ML-based feature data for predicting a beam blockage between the apparatus and a network entity; means for determining to switch from the current ML-based feature data extraction model to the one of the ML-based feature data extraction models based at least in part on the message; and means for transmitting, in response to the switch, the ML-based feature data for predicting the beam blockage based on the one of the ML-based feature data extraction models.

In an aspect of the disclosure, a method for wireless communication, a computer-readable medium, and an apparatus are provided. The apparatus may be a network node. The network node includes a processor; memory coupled with the processor; and instructions stored in the memory and operable, when executed by the processor, to cause the network node to: receive first ML-based feature data from a UE based on a first ML-based feature data extraction model of the UE; transmit a message instructing the UE to switch from the first ML-based feature data extraction model to a second ML-based feature data extraction model of the UE based on a state of the UE; receive second ML-based feature data from the UE based on the second ML-based feature data extraction model of the UE; and determine a beam blockage prediction in response to the second ML-based feature data.

In an aspect of the disclosure, an apparatus is provided. The apparatus may be a network node. The network node includes means for receiving first ML-based feature data from a UE based on a first ML-based feature data extraction model of the UE; means for transmitting a message instructing the UE to switch from the first ML-based feature data extraction model to a second ML-based feature data extraction model of the UE based on a state of the UE; means for receiving second ML-based feature data from the UE based on the second ML-based feature data extraction model of the UE; and means for determining a beam blockage prediction in response to the second ML-based feature data.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 shows a diagram illustrating an example disaggregated base station architecture

FIG. 5 is a conceptual diagram of an example Open Radio Access Network (O-RAN) architecture.

FIG. 6 is a flow diagram of an example training and inference model.

FIG. 7 is a top-down diagram of a coverage area for wireless communications using adaptive ML training and inference extraction for beam prediction.

FIG. 8 shows ML service entities at the ML server and the UE, respectively, using signaling procedures and parameters for adaptive sensing and feature extraction and reconfiguring sensors of the UE.

FIG. 9 is an example flow diagram of adaptive model training and inference functions for predicting beam blockages using a session based on the data gathered from the sensors and ML models of a UE.

FIG. 10 is a conceptual diagram of an example where training or inference for feature extraction models at a UE may be separated from the training or inference for prediction models at an ML service entity of an ML server or base station.

FIG. 11 is a flow diagram of an example communication flow between a UE and an ML service entity of an ML server or base station in which the ML service entity may request adaptive sensing and feature extraction for prediction tasks to better support separated ML training, inference and/or performance optimization.

FIG. 12 is a conceptual diagram illustrating an example of an ML service entity at a UE including multiple feature extraction models.

FIG. 13 is a conceptual diagram illustrating an approach for adaptive sensing and feature extraction in which the ML service entity at the ML server or base station includes multiple ML models.

FIG. 14 is a conceptual diagram of an example where training or inference for feature extraction models at a UE may be joined or associated with training or inference for prediction models at the ML service entity of the ML server or base station.

FIG. 15 is a flow diagram of an example communication flow between a UE and an ML service entity of the ML server or base station in which the ML service entity may request adaptive sensing and feature extraction for prediction tasks to better support joint ML training, inference and/or performance optimization.

FIG. 16 is a flow diagram of an example communication flow between a UE and an ML service entity of the ML server or base station in which the ML service entity or the UE may trigger sensor configuration or reconfiguration for prediction tasks to better support ML training, inference and/or performance optimization.

FIG. 17 is a flowchart of a method of wireless communication at a UE.

FIG. 18 is a flowchart of a method of wireless communication at a network node.

FIG. 19 is a diagram illustrating an example of a hardware implementation for an example apparatus.

FIG. 20 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

With fifth generation (5G) wireless technologies and beyond, wireless networks can operate with substantially higher frequency bands that range, for example, from 28 Gigahertz (GHz) (“FR2”), 60 GHz (“FR4”) to above 100 GHz in the Terahertz (THz) band. Due to the high attenuation and diffraction losses inherent in these bands, the blockage of line-of-sight (LOS) paths can profoundly degrade wireless link quality. Blockages can occur frequently, and the received power at the user device can drop significantly if an LOS path is blocked by moving obstacles such as vehicles, pedestrians, or the like.

To overcome these rapid variations in link quality at such high frequencies caused by LOS blockages, vehicles can be equipped with UEs and onboard sensors (e.g., RADARs, LIDARs, cameras, etc.) to provide a radio network with information about moving obstacles that may ultimately degrade signal quality by causing beam blockage. Sensing information can be leveraged to provide radio network information of the communication environments as well as moving obstacles that could otherwise block the LOS beam path.

The context of the problems inherent in the above approach may arise where a vehicle (also called an “ego” vehicle) equipped with sensors, enters into the coverage area in which an ML service entity is included. The coverage area may include moving objects (vehicles, pedestrians, etc.) and stationary objects (buildings), each of which can impact the LOS. The ML service entity may reside within a network entity for that coverage area, for example, a base station such as a Node B, an evolved Node B, a New Radio base station or 5G Node B (gNB). Alternatively, the network entity may itself be the ML service entity, such as an ML service entity residing within a base station. The ML service entity may reside within a base station, in an ML server co-located with the base station, in an ML server located near the base station, or in an ML server located elsewhere (such as in a cloud or edge server). The received sensor information from the entering ego vehicle's UE and potentially from other vehicles in the coverage area may assist the base station working with the ML server or ML service entity.

With the sensing information provided by the on-board sensors of the vehicles and their ML models, the ML service entity may assist the base station in gaining an overall view of the environment in which the ML service entity is included and in proactively managing beams to improve radio link quality. The ML service entity may accomplish this beam management by performing training tasks to obtain models such as a beam blockage prediction model, inference tasks to make predictions of blocked beams based on the trained models, and performance optimization tasks to improve the models. However, due to the mobility of vehicles equipped with sensors and the dynamic nature of the objects which may result in blocked beams, there is a need for the sensing to be dynamic and adaptive in this context. Correspondingly, there may also be a need for the sensors to be reconfigured adaptively and frequently in this context.

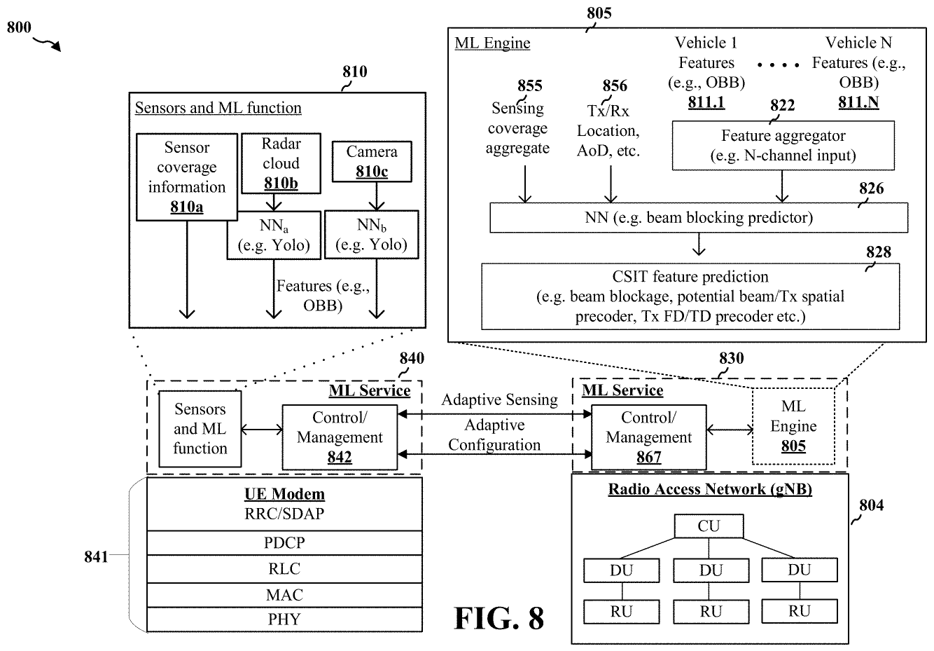

Accordingly, aspects of the present disclosure provide signaling procedures and parameters through which a UE's ML service entity and an ML service entity at an ML server or base station may leverage adaptive sensing and feature extraction, in addition to reconfigurable sensors on-board the vehicle, in order to better serve the training, inference, and performance optimization tasks of the ML service entity at an ML server or base station. For example, a UE may support ML service with equipped sensors such as radar or camera. The UE may also support an ML function with one or more neural networks (NNs) for extracting features from sensor data that may have been collected from a vehicle RADAR or a camera, for example. In one aspect, the UE may include an ML control or management function within its ML service entity which is configured to control and exchange messages for adaptive sensing and feature extraction. The ML control or management function may additionally be configured to configure or reconfigure sensors through requests or instructions. The ML service entity including these functions may also reside on the vehicle UE. In another aspect, the ML service entity at the vehicle UE may reside in a layer above the UE modem's 5G protocol stack (FIG. 8), such as in an application layer. Similarly, the ML service entity at the ML server or base station may reside in a layer above the protocol stack of the radio access network (RAN). As such, the ML service entity at the vehicle UE may communicate directly with the ML Service entity at the ML server or base station to provide an adaptive or dynamic beam blockage prediction service. In other configurations, the ML service entity at the UE may communicate with the ML service entity at the base station via an RRC connection.

In still other aspects, an ML service entity at the ML server or base station performing a centralized beam blockage prediction service at the ML server may include one or more ML engines which can predict beam blockages dynamically. The ML engine(s) may achieve these predictions by aggregating the received sensing data or features from a plurality of UEs/vehicles. The ML engine(s) may thereupon proactively direct the base station to adjust beam operations as a result.

As noted above, the ML service entity may reside within the base station or at an ML server co-located with the base station, located near a base station, or located elsewhere such as within a cloud or edge server. Also as noted, the ML service entity may include procedures for adaptive sensing and feature extraction. In one example, the control or management function of the ML service entity of the base station or ML server may request the UE to switch between different ML models of the UE based on a training or inference need, and the control or management function of the UE's ML service entity may adapt its ML models accordingly. For instance, if a state of the UE in the dynamic environment of the ML server or base station indicates more accurate inferences from the UE (with longer inference times) or faster inferences from the UE (with shorter inference times), the ML service entity at the base station or ML server may instruct the UE to switch to a more complex or less complex feature extraction model respectively. In the context of beam blockage prediction, more accurate inferences in response to a UE model switch may result in more accurately predicted beam blockages, which may be desirable in environments where UEs are moving slowly, are within an environment having a large number of dynamic objects, or similar UE state. Alternatively, faster inferences in response to a UE model switch may result in more quickly predicted beam blockages, which may be desirable in environments where UEs are moving quickly, are within an environment having a small number of dynamic objects, or similar UE state.

Moreover, in other examples, the control or management function of the ML service entity of the base station or ML server may apply multiple beam management models such as beamforming and beam tracking and adaptively instruct the ML service entity of the UE to provide different training or inference data for these models accordingly. In other procedures, the control or management function of the ML service entity of the base station or ML server may adaptively request UEs to communicate their confidence for each feature extraction or inference or to apply a model capable of communicating such confidence levels. In any of these procedures, the control or management function of the ML service entity of the base station or ML server may aggregate data received from various UEs into its ML model(s), and communicate aggregated performance characteristics of its model(s) such as back propagated gradients to various UEs to adapt their own feature extraction model(s) as part of a joint system for ML training, inference, and/or performance optimization. Alternatively, the ML service entity of the base station or ML server may refrain from communicating such information to maintain a separation between its own model(s) and the local feature extraction models of the various UEs.

In further examples, the ML service entity of the base station or ML server, and the ML service entity of the UE, may include procedures for adaptively configuring or reconfiguring UE sensors. These procedures may take place during ML service discovery and session establishment, ML model training, ML model inferring or feature extraction, and/or ML model performance optimization. In one example, the control or management function of the ML service entity of the base station or ML server may configure or reconfigure UE sensors adaptively based on ML service training requirements, ML service inference requirements, ML service performance requirements, network traffic load, and/or a number of UEs in the area. In another example, the control or management function of the ML service entity of the UE may configure or reconfigure UE sensors adaptively based on vehicle sensor setting and configurations, sensor availability, sensor selection, location changes, speed changes, direction changes, radio link quality with the gNB or ML server, UE vehicle ADAS (advanced driver-assistance systems), and/or UE sensor occlusion.

As a result, the ML service entity of the base station or ML server may adaptively and dynamically instruct different vehicles to provide different data, extracted features, and model results to predict beam blockages. For instance, to improve training, inference, and/or performance optimization, the ML service entity of the base station or ML server may adaptively instruct the UE to switch between feature extraction models, configure or reconfigure sensor parameters, model parameters (within a given model), or object tracker parameters of the UE, reselect sensor types of the UE and task specifications for the UE to accomplish, perform forward passes in its models based on aggregated UE data, provide aggregated feedback of gradients or other performance characteristics to the UEs for the UEs to adaptively adjust their sensing and/or feature extraction, or perform a combination of these aspects. Moreover, the ML service entity of the base station or ML server may adaptively trigger sensor reconfiguration at the UE based on training, inference, or performance optimization criteria, system loading, a number of UEs in the area, or similar factors, and/or confirm a UE's sensor reconfiguration adaptively triggered by the ML service entity of the UE based on sensor availability, sensor selection, location changes, speed changes, direction changes, radio link quality, and the like. In response to these adaptive instructions, via the ML service entity of the base station or ML server, the base station can dynamically partition and schedule the beam transmissions among the entities in a manner that prevents or reduces LOS interference.

Additionally, it should be understood that while the examples of aspects described throughout this disclosure specifically refer to beam blockage prediction or predicting beam blockages, the disclosed aspects are not limited in application to beam blockage prediction. Rather, the disclosed aspects may similarly apply to beam prediction, beam management, scheduling, load balancing, or other network functions in other examples. For instance, the ML service entity may adaptively instruct the UE to switch between feature extraction models, trigger sensor reconfiguration, and the like not only to predict and prevent LOS beam blockages as previously described, but also or alternatively to predict best beams for communication with a UE, perform beam management (beamforming training or refinement), optimally schedule resources to the UE, balance current traffic loads, and the like, in response to sensor data or extracted features from UEs.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

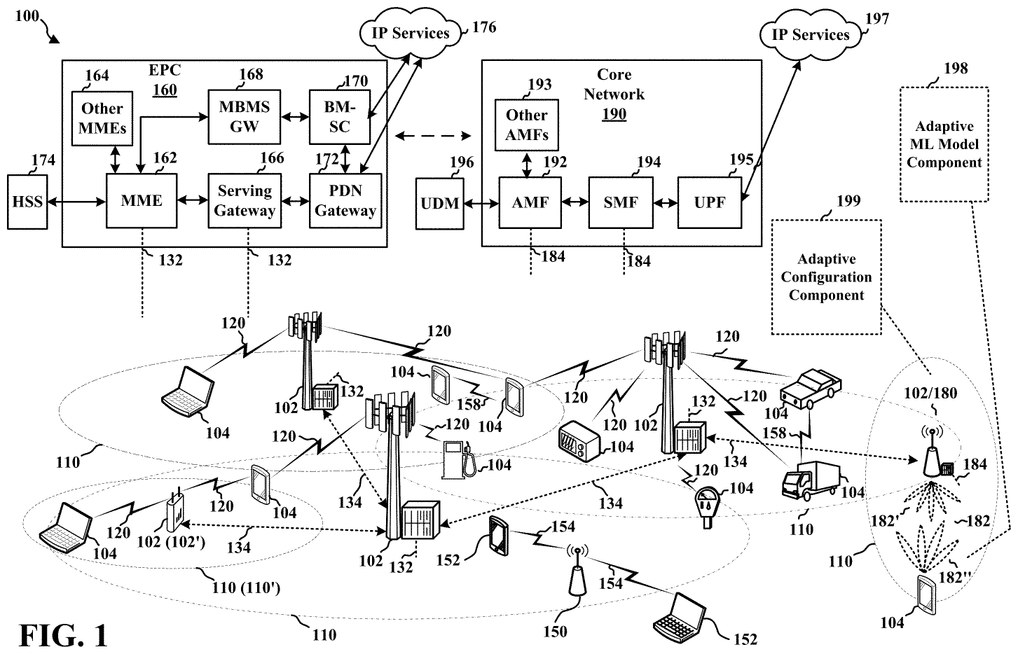

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., Si interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include an adaptive ML model component 198 configured to receive a configuration indicating the UE to switch between a plurality of ML-based feature data extraction models of the UE based on a state of the UE; determine to switch from a first one of the ML-based feature data extraction models to a second one of the ML-based feature data extraction models in response to the configuration; and transmit, to a network node, ML-based feature data for beam blockage prediction based on the second one of the ML-based feature data extraction models. The UE 104 in this instance may be in a vehicle equipped with sensors and ML inference models for feature extraction, although the UE may be another automotive form of transport, or with a pedestrian, etc. The network node may be, for example, an ML service entity at the base station 180 or in an ML server co-located with the base station 180 or near the base station, the base station itself, the ML server itself, a component of a disaggregated base station, or some other network entity. The UE may also include a local ML service entity containing ML models which extracts features from sensor data. This local ML service entity at the UE is different from the ML service entity at, co-located with, or near the base station, which ML service entity may predict beam blockages based on aggregated sensor data or inferences from multiple UEs.

Still referring to FIG. 1, in certain aspects, the base station 180 in FIG. 1 may include an adaptive configuration component 199 configured to receive first ML-based feature data from a UE based on a first ML-based feature data extraction model of the UE; transmit a configuration that indicates the UE to switch from the first ML-based feature data extraction model to a second ML-based feature data extraction model of the UE based on a state of the UE; receive second ML-based feature data from the UE based on the second ML-based feature data extraction model of the UE; and determine a beam blockage prediction in response to the second ML-based feature data. For example, the base station may determine a beam blockage prediction by obtaining one or more predicted blocked beams from an ML service entity or ML inference host with which the base station may interface. The ML service entity or ML inference host may be physically located at the base station 180 or may be in an ML server co-located with the base station 180 or near the base station. The ML service entity, or the base station or ML server interfacing with the ML service entity, may exchange signals with the UE 104 to perform adaptive sensing and feature extraction, as well as sensor configuration and reconfiguration. For example, the ML service entity or base station/ML server may engage in signaling procedures and parameters with the UE 104 to collect sensor data and inferences, to request the UE to adapt its ML models and sensors, and to obtain updated sensor data for beam blockage prediction at or from the ML service entity. For instance, predictive and inference-based techniques can be used to determine the likelihood of a beam blockage, in which the ML service entity uses this information to propose an alternative beam selection path, for example, to avoid a predicted line of sight obstruction.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

Additionally or alternatively, the concepts and various aspects described herein may be of particular applicability to one or more specific areas, such as for use in Open-Radio Access Network (O-RAN) architectures with RAN intelligent controllers (RICs) as described in greater detail below.

In some aspects, the term “receive” and its conjugates (e.g., “receiving” and/or “received,” among other examples) may be alternatively referred to as “obtain” or its respective conjugates (e.g., “obtaining” and/or “obtained,” among other examples). Similarly, the term “transmit” and its conjugates (e.g., “transmitting” and/or “transmitted,” among other examples) may be alternatively referred to as “provide” or its respective conjugates (e.g., “providing” and/or “provided,” among other examples), “generate” or its respective conjugates (e.g., “generating” and/or “generated,” among other examples), and/or “output” or its respective conjugates (e.g., “outputting” and/or “outputted,” among other examples).

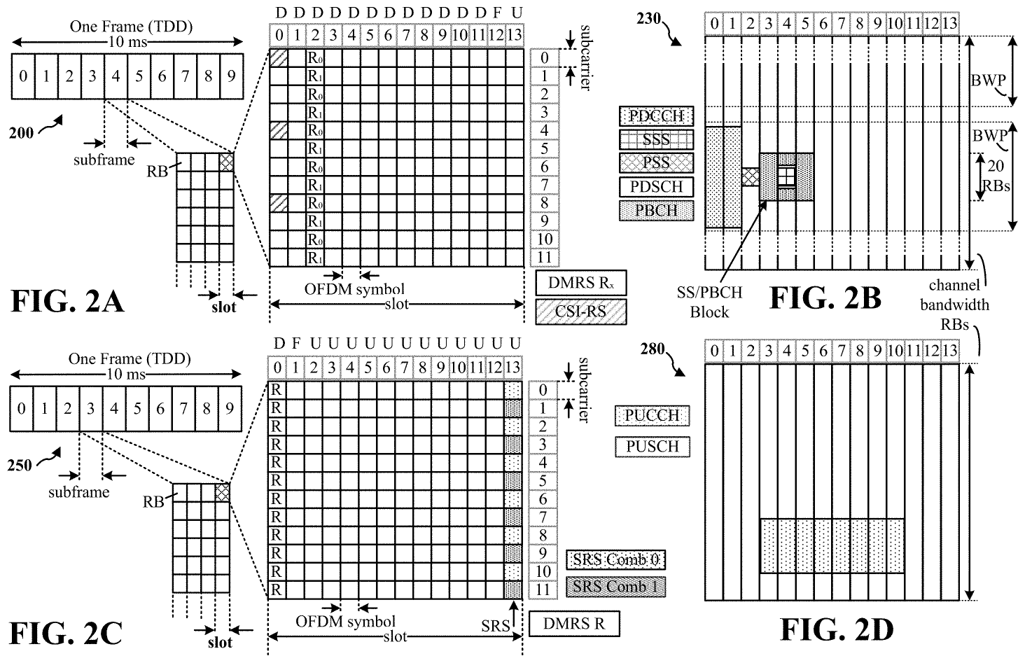

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ., there are 14 symbols/slot and 2^{μ} slots/subframe. The subcarrier spacing and symbol length/duration are a function of the numerology. The subcarrier spacing may be equal to 2μ *15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

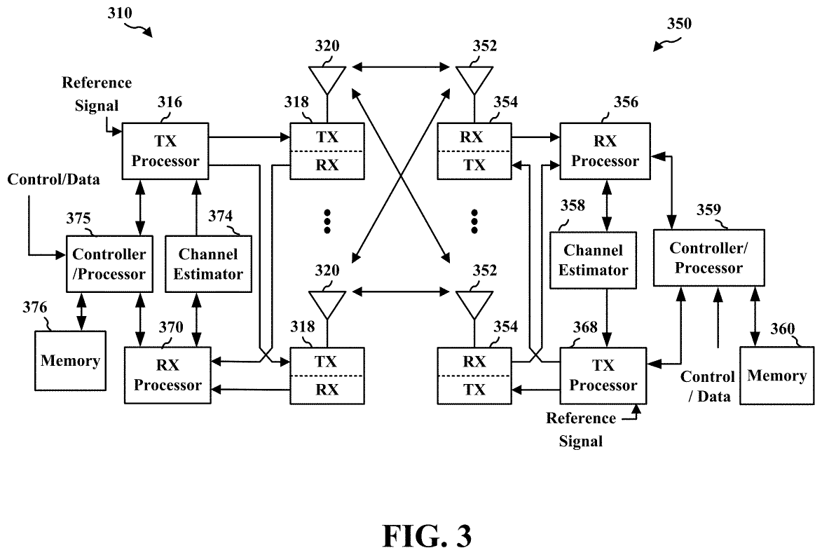

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with adaptive inference model component 198 of FIG. 1. At least one of the TX processor 316, the RX processor 370, and the controller/processor 375 may be configured to perform aspects in connection with adaptive configuration component 199 of FIG. 1.

With the advent of new wireless technologies and higher transmission beam frequencies, users can enjoy many of the concomitant benefits of these technologies such as faster data rates, artificial intelligence, and more sophisticated machine learning models for performing a variety of tasks. Such technologies, like 5G and the latest Wi-Fi standards, can be used in conjunction with different architectures such as O-RAN. In a disaggregated base station where the base station functionality may be physically distributed, the ML service entity that performs beam interference prediction may be located at an ML server, or at a near-real time RAN Intelligent Controller (MC) or a different network node dictated by the specifics of the particular architecture.

Along with these enhanced benefits, the high frequencies also give rise to new challenges for an exemplary coverage area serviced by a base station that may be in a congested area of traffic in a downtown area, for example. The faster network speeds and higher frequencies that run in 5G from 28 GHz to 100 GHz or more, together with the increased number of beams, are more likely to result in LOS blockages that, if left unaddressed, can profoundly degrade performance of the system. These potential blockage problems may be exacerbated by the higher attenuation and diffraction losses that are inherent in these higher frequencies. For these reasons, it is important to establish an effective set of protocols to predict such blockages caused by moving obstacles such as pedestrians, vehicles, or other objects, and to redirect communications in or near real time to prevent them.

It should be noted that the term “UE” in this disclosure may often refer to the UE equipped in a vehicle, as is often apparent from the context. For the same reasons, the use of the term “vehicle” may also encompass the UE and/or physical sensors equipped within the UE. The disclosure is not so limited, however, as UEs herein may likewise refer to any UE, whether carried by a user, integrated in a car, truck or train, or otherwise.

As a starting point to overcome these prospective rapid variations of the link quality of the communication systems operating at these higher frequencies due in part to LOS path blockages, manufacturers can equip the UE-based vehicle with one or a plurality of on-board sensors to provide fast radio network information to the base station. These sensors may include, among others, one or more cameras, Radio Detection and Ranging systems (RADARs), and Light Detection and Ranging systems (LIDARs). The sensors may be coupled to the UE in the vehicle to transmit sensing information relating to the communication environments in the relevant coverage area in addition to moving obstacles that potentially stand to block the LOS path and degrade communication quality.

In an aspect, perceptive wireless communications may be employed by the relevant network components. For example, upon receiving the sensing information provided by the vehicle sensors, a radio network can employ ML models to detect or predict prospective blockages and proactively initiate beam management and, where necessary, hand-off procedures.

While the various aspects may involve a plurality of vehicles communicating with the network, which in turn aggregates this information, for simplicity in some configurations, the disclosure refers to the relevant communications between a vehicle and a base station, for example, rather than several vehicles equipped with sensors and ML functions. The reference to a single UE-based vehicle is for simplicity and to avoid unduly obscuring the concepts herein. It will be appreciated by those skilled in the art in reviewing this disclosure, however, that a coverage area may involve communications with a plurality of UEs, in vehicles and otherwise.

Thus, in an aspect, an objective herein, such as in the context of millimeter wavelength signaling, is to gather sensing information from each equipped UE in the coverage area and leverage one or more ML models to predict beam blockages and best beams. Aspects of this disclosure are directed to, inter alia, addressing the problems of how an ML service entity at a ML server or base station may perform discovery of these UE-based vehicles that support sensor-based ML functions, and addressing how, if such ML service discovery can be effected, can an ML service session between the ML service entity and the vehicle-based UE be effectively established to enable the ML service entity to collect relevant sensing information for use in ML training, inference, and performance optimization. Additional aspects of the disclosure are also addressed herein.

The ML service entity at the ML server or base station, in addition to performing other functions, may be principally responsible for mediating UE/ML server communications and processing sensing information, extracted features, etc., to ultimately use dynamic and adaptive ML training and inferences to make beam predictions. For instance, the ML service entity may include one or more ML models to make predictions or inferences of beam blockages from received sensing information or may perform training of one or more ML models for predicting blockages. The ML service entity may reside in the base station. In other configurations, the ML service entity may reside in an ML server that is co-located with the base station, or located near the base station.

Other configurations involving alternative network deployments may in some instances affect the physical or virtual location of the ML service entity. One example of such a configuration includes a disaggregated network architecture, in which the ML service entity may be physically or logically deployed in a separate network node than those of a disaggregated base station. For example, the base station may include multiple units or network nodes, such as a central or centralized unit (CU), distributed unit (DU), radio unit (RU), or the like, and the ML service entity may be physically or logically separated from one or more of these network nodes.

More generally, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a base station (BS) (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

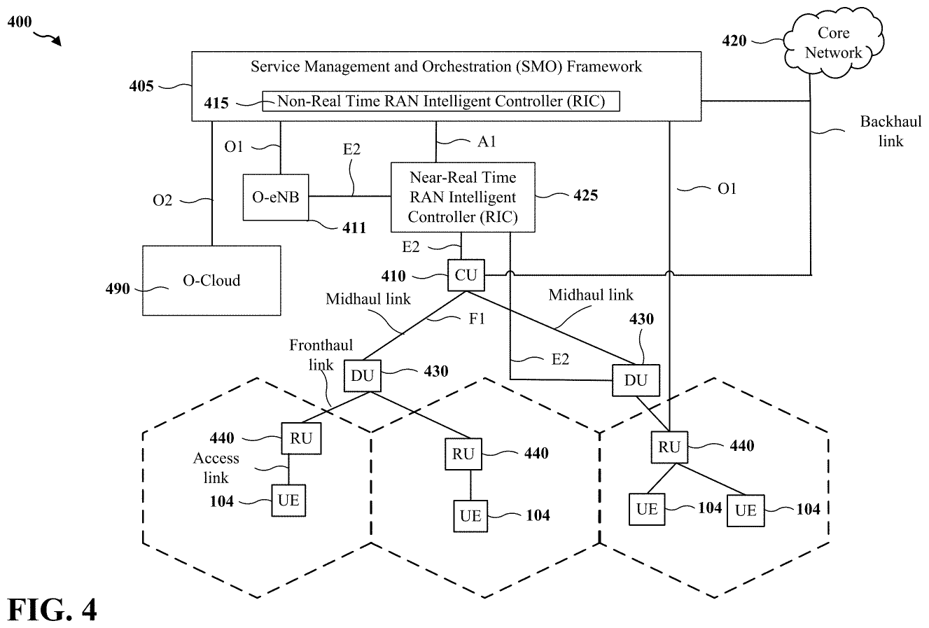

FIG. 4 shows a diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a Near-Real Time RIC 425 via an E2 link, or a Non-Real Time RIC 415 associated with a Service Management and Orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit—User Plane (CU-UP)), control plane functionality (i.e., Central Unit—Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 120. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements, which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include the Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT MC 425 and may be received at the SMO Framework 405 or the Non-RT MC 415 from non-network data sources or from network functions. In some examples, the Non-RT RIC 415 or the Near-RT MC 425 may be configured to tune RAN behavior or performance. For example, the Non-RT MC 415 may monitor long-term trends and patterns for performance and employ AI/ML models to perform corrective actions through the SMO Framework 405 (such as reconfiguration via O1) or via creation of RAN management policies (such as A1 policies).

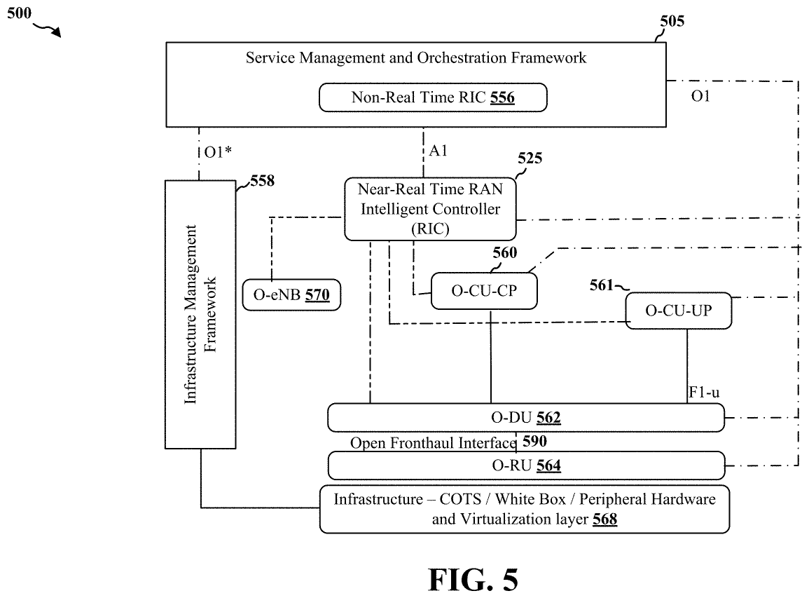

FIG. 5 is a conceptual diagram of an O-RAN architecture 500. O-RAN 500 beneficially provides an open architecture to which different network operators can link to provide a systematic, interoperable network. The conventional O-RAN architecture may be configured to include certain key functional elements. These include an SMO framework 505 (which may include a Non-RT RIC 556), as also seen in FIG. 4), an O-DU software component 562, a multi-RAT CU protocol stack (which may in turn include an O-RAN CU-CP (O-CU-CP) 560 and an O-RAN CU-UP (O-CU-UP) 561), a Near-RT MC 525, an O-RAN eNB 570, an Infrastructure Management Framework 558, and an Infrastructure—Commercial Off The Shelf (COTS)/White Box/Peripheral Hardware and Virtualization Layer 568. Referring back to FIG. 4, SMO framework 505 may correspond to SMO framework 405, non-RT RIC 556 may correspond to Non-RT MC 415, O-DU software component 562 may correspond to DU 430, O-CU-CP 560 and O-CU-UP 561 may correspond to functionality of CU 410, Near-RT MC 525 may correspond to Near-RT RIC 425, O-RAN eNB 570 may correspond to O-eNB 411, and Infrastructure Management Framework 558 may be included in O-Cloud 490.

For simplicity and to avoid unduly obscuring the present disclosure, various inputs and outputs have been omitted from the architecture of FIG. 5, including signals to and from O-CU-CP 560 and O-CU-UP 561. The non-RT component 556 is capable of processing data offline or processing data quickly but typically greater than a threshold, such as one millisecond. Accordingly, the non-RT component 556 can process tasks for which there is not an immediate need for a response, but that may have a temporal allowance which makes the non-RT component 556 a natural choice to process the data.

One or more of these components may also interact with the radio unit (RU) hardware 564. For example, the O-DU component 562 may communicate with the O-RU component 564 via the open fronthaul interface 590. Components such as Non-RT MC 556 and Near-RT RIC 525 may interact with the O-RU hardware 564 to assist O-RU 564 in running more efficiently and to optimize the O-RU 564 in real time as part of the RAN cluster to deliver a better network experience to end users. Both the Non-RT MC 556 and the Near-RT MC 525 may be used in connection with the service discovery and service session procedures due to their ability to process priority data at high speeds or in the background.

As discussed with reference to FIGS. 4 and 5, the Non-RT MC 415, 556 includes several functions potentially relevant to the aspects herein. The Non-RT RIC 415, 556 includes functions such as configuration management, device management, fault management, performance management, and lifecycle management for all network elements. The Non-RT MC 415, 556 can use data analytics, artificial intelligence (AI) and ML training and inference to determine the RAN optimization actions, for which it can leverage the service management and orchestration (SMO) framework 405, 505, including data collection and provisioning services of the O-RAN nodes.

The Near-RT MC 425, 525 may utilize embedded processors or intelligent code for per-UE controlled load balancing, RB management, interference detection and mitigation, and other functions that are desirable to process in a prioritized manner in order to successfully use ML training/inference models. The Near-RT RIC 425, 525 may provide quality-of-service (QoS) management, connectivity management and seamless handover control. Near-RT RIC 425, 525 may also leverage the near real-time state of the underlying network and may feed RAN data to train the AI/ML models. The modified models can then be provided to the Near-RT RIC to facilitate high quality radio resource management for the subscriber.

In some configurations, the Near-RT RIC 425, 525 performs similar beam prediction management functions as the non-RT RIC 415, 556 for data that does not require near-RT priority. More often, due to the nature of its temporal priority, Near-RT RIC 425, 525 executes the different ML model and beam interference predictions for the different actors (such as, for example, the O-CU-CP 560, O-CU-UP 561, O-DU 562 and O-RU 564). The latter four components are functions with the base station, which four elements show the disaggregation of the elements in this architecture. Further, in this configuration, the Near-RT RIC 425, 525 is co-located with the gNB because it supports the loop delay in the inference operation, which is faster than 1 second.

The Non-RT RIC 415, 556, as noted, may support inference operations with a delay slower than 1 ms, and can be located near the gNB, such as being nearby in a cloud or edge server. In short, the Near-RT RIC 425, 525 or Non-RT RIC may act as an inference host in the beam prediction architecture, and in the disaggregated base station, the four actors 560, 561, 562 and 564 are portions of the gNB application.

In sum, with respect to the different prospective network configurations and server-based architectures described with reference to FIGS. 4 and 5, including the aggregated and disaggregated base stations, O-RANs, SMOs (including Non-RT RICs), Near-RT RICs or other network frameworks or modifications thereof, the principles of the present disclosure are intended to encompass any one or more of these implementations.

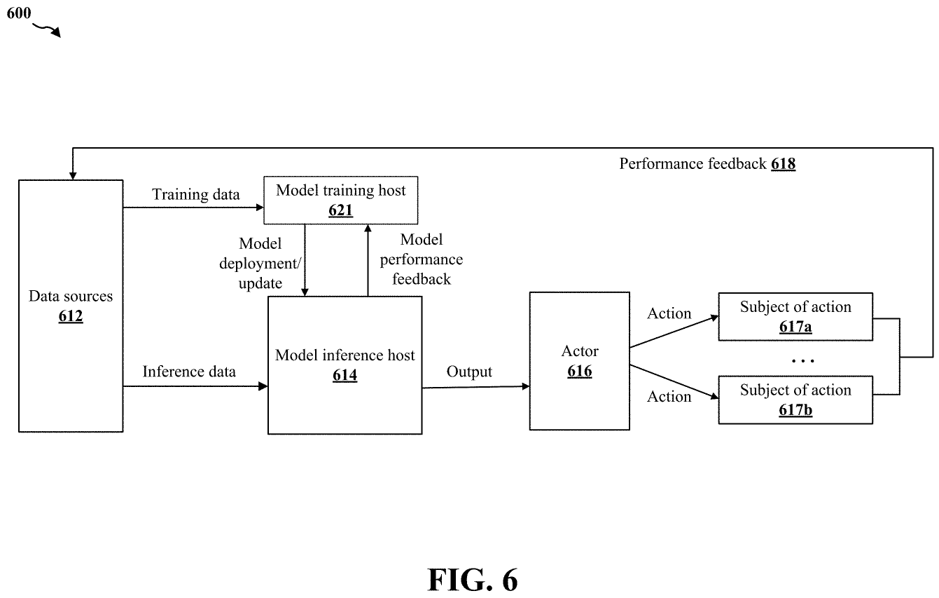

FIG. 6 is a flow diagram 600 of an example training and inference model. Data sources 612 may include training and inference data collected from network entities. A model training host 621 and a model inference host 614 may each be included in, or alternatively synonymous with, the Near-RT RIC 425, 525 and/or the Non-RT RIC 415, 556. Model deployments or updates from model training host 621 may be fed back to model inference host 614, and model performance feedback may be provided to the model training host 621. The training and inference output from model inference host 614 can be provided to an actor 616. The actor 616 may be any entity within the 3GPP network. For example, if the actor is the gNB, the subjects of action 617a and 617b could be updating the models, which in turn can be provided back to the data sources 612 as performance feedback 618. Other subjects of action 617a, 617b may include energy saving, load balancing, mobility management, coverage optimization, and the like. Actions that do not require near-real time treatment can be processed via the Non-RT RIC 415, 556. As noted previously, actions relating to establishing model and inference training based on extracted sensor information (e.g., the orientation bounding boxes (OBBs) to estimate objects locations, scales and orientations based on YOLO algorithm) and inference models are performed by an ML service entity at the ML server or base station.

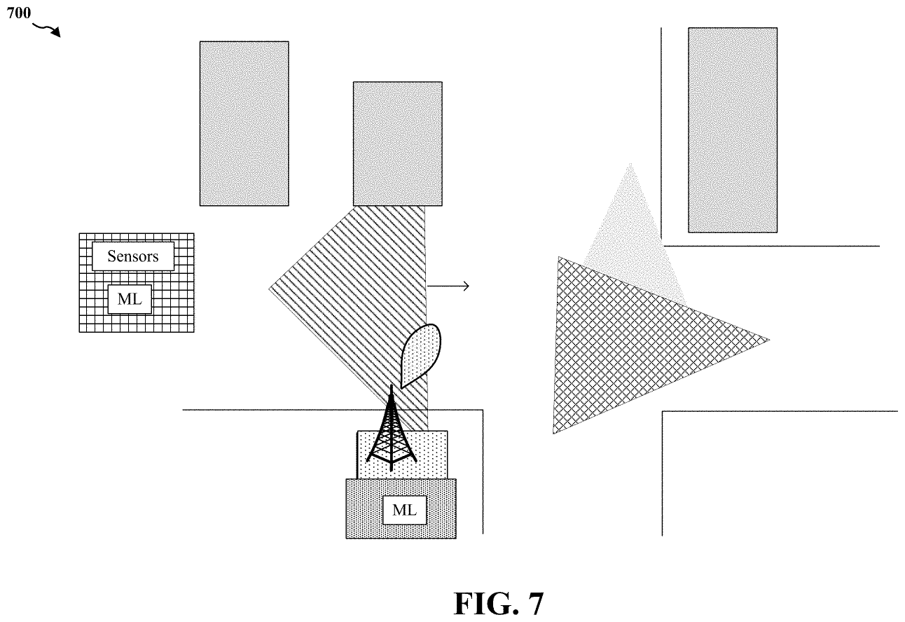

FIG. 7 is a top-down diagram of a coverage area 700 including wireless communications using adaptive ML training and inference extraction for beam prediction. A vehicle 704a (which may be referred to as an “ego” vehicle) may enter a coverage area, e.g., a cell of gNB 702. The vehicle/UE 704a may be equipped with sensors, such as cameras, RADARs, LIDARs, or other sensing equipment. The gNB 702 may send a transmission 732 to the UE 704a requesting sensing information as the vehicle enters the area. Sensing information may include, for example, raw sensor data or inference data. Raw sensor data may include, for example, RADAR or LIDAR point clouds, camera pixels, and the like, which data is obtained from sensors of the vehicle/UE. Inference data may include, for example, orientation bounding box (OBBs) or other extracted features which the vehicle/UE 704a may derive as output from an ML model in an ML service entity 705 of the UE, based on raw sensor data. The ML model for extraction may be, for example, a neural network such as a multi-layer perceptron (MLP), a convolutional neural network (CNN), or a recursive neural network (RNN). The vehicle 704a may respond to the transmission 732 by sending the sensing information, which may serve as training data or inference data for beam blockage prediction. For example, training data is data that the ML service entity 749 of gNB may use to obtain or train a beam blockage prediction model, while inference data is data that the ML service entity 749 of gNB may use to predict beam blockages using the trained model. For instance, the ML service entity 749 of gNB may determine from the inference data that a feature exists in the LOS of a beam to the vehicle/UE 704a. The feature could be a wall or a pedestrian, for example.

An ML service entity 749 may be located in gNB 702, or co-located with the gNB or located near the gNB in an ML server, and include a model training host and a model inference host. The model training host includes a training model, such as a neural network, which generally determines and deploys weights for an inference model at the model inference host. The inference model may be, for example, a neural network that performs beam blockage prediction based on inference data received from UEs. For instance, the inference model at the ML service entity 749 may be a beam blockage prediction model. The inference host may provide output from the inference model to detect blocked beams. The output from the ML service entity 749 may be provided to an actor, such as the base station gNB 702. The ML service entity 749 associated with gNB 702 may also analyze the data and create gradients, and provide the gradients back to the model training host so that new weights can be provided and the training model (and optionally, based on performance feedback, inference models) can be updated. Based on this performance optimization, new actions may also be performed at the gNB 702, such as changing the beam responsive to the information provided by one or more vehicles.

The coverage area 700 may include static objects, such as buildings, and moving objects, such as cars, buses, trucks, pedestrians, etc. The radio link quality between a UE and gNB can be impacted by both moving and stationary objects. For example, the gNB 702 may currently schedule to transmit a beam 707 directionally to a pedestrian UE 704d, the latter having a receive beam 709.

Referring still to FIG. 7, the ML service entity 749 may query vehicle UEs 704a, 704b and 704c for sensing information based on their sensors. The ML service entity 749 may instruct one of more of these vehicles to adjust the direction or orientation of the sensors, for example the field of views (FoV) 764a, 764b, 764c, in order to elicit more accurate feedback. The type of sensor of a UE may be changed. The ML service entity 749 may make these determinations based on the obstructions it discovers in the coverage area, including buildings 722, 724, 726, and 730, and pedestrians 751 and 704d. Based on the exchange of training and inference data exchanged and the models produced, the ML service entity 749 can change the pattern of beam predictions to reduce the chance of signal interference. For example, the ML service entity 749 may predict that truck 711 may enter the LOS of beam 707 to pedestrian 704d and cause a beam blockage, and the gNB may change to a different beam accordingly.

It should be noted that the above FIGS. 5-7 are shown as an example environment for some possible implementations in which aspects of the present disclosure can be applied. The illustrations also highlight the difference between base station monolithic architectures versus disaggregation. While the network architecture may differ in these cases, the principles of the disclosure are intended to apply with equal force to the different cases. Other network types are also possible and may be equally suitable for application of the principles herein.

FIG. 8 shows a conceptual diagram 800 of an example of an ML service entity 830 interfacing with gNB 804 (or ML server) and an ML service entity 840 at the UE, respectively, and which applies signaling procedures and parameters for adaptive sensing and feature extraction and sensor reconfiguration. The ML service entity 840 at the UE generally assists in collecting sensing information and in communicating with the ML service entity 830 at the gNB or ML server. The ML service entity 840 at the UE includes sensors and one or more ML functions, an example of which is shown in blown up form as Sensors and ML function 810. In this configuration, the ML service entity 840 is positioned atop a protocol stack 841 of the UE modem. At sensor and ML function block 810 is a sensor coverage information component 810a which provides UE sensor parameters such as field of view, resolution, update rate, and the like. A radar cloud 810b system and a camera 810c are also shown in this example, in which the ML service uses a RADAR and camera together with an object detection or inference model (for example, based on a You Only Look Once (Yolo) algorithm) incorporating neural networks NNₐ and NN_{b}, respectively. In particular, NNₐ and NN_{b} respectively extract features such as orientation bounding boxes (OBBs) from RADAR point clouds or camera pixels sensed by the UE. While the ML model Yolo is specifically referenced for the neural networks in this example, it should be understood that the neural networks are not limited to this architecture and may in other examples be based on other frameworks including but not limited to MobileNet and EfficientNet.

In order to make near-real time predictions about potential beam interference and performance degradations, there is a need in the art to establish a mechanism for adaptive sensing and sensor reconfiguration. Due to the mobility of vehicles equipped with sensors and the dynamic nature of detectable objects, the sensing and feature extraction should be adaptive to better serve the ML service entity's training, inference, and performance optimization tasks. In one case, the ML service entity 830 may be configured to control sensors of the UE and models at the UE's ML service entity 840 through an exchange of messages for adaptive sensing and feature extraction. In another case, the ML service entity 830 may be configured to configure or re-configure sensors of the UE through a configuration or re-configuration request, or to receive and confirm sensor configuration or re-configuration requests from the UE, to adapt to the dynamic environment of the UE. The adaptive sensing and sensor reconfiguration may in turn allow the ML service entity 830 to improve its training, inferences, and performance optimization tasks to make more accurate beam blockage predictions.

Referring back to FIG. 8, the ML service entity 840 at the UE includes a control/management component 842 including an adaptive sensing function and a sensor reconfiguration function. ML Service entity 830 at the ML server or base station also includes a corresponding control/management component 867 including an adaptive sensing function and a sensor reconfiguration function. These components together form one or more data streams relating to a beam blockage prediction service. Accordingly, in this aspect, adaptive sensing is configured by a communication from the adaptive sensing function of the control/management component 867 of the ML service entity 830. Moreover, in another aspect, sensor reconfiguration may be instructed by a request or other communication from the sensor reconfiguration function of either the control/management component 842, 867 of the ML service entity 830 or the ML service 840 at the UE.

In the aspect shown in FIG. 8 and as will be made more apparent later, the communication between the entities does not occur at a lower layer but may instead occur in some examples at a layer above the UE modem's protocol stack on the UE side, and the ML service entity 830 similarly resides in a layer above the RAN (gNB at 804, including in this deployment an exemplary hierarchy of one or more CUs, DUs and RUs) on the gNB side. Referring still to FIG. 8, the ML service entity 830 further includes an ML Engine 805 (or a plurality of such engines). A blown up version of ML Engine 805 is shown at the upper right of the figure. The ML Engine 805 can use data from a plurality of UEs in the coverage area to perform beam blockage prediction, provide feedback to the UEs, and perform beam management functions, making the desired changes where necessary.

In the upper right of the blown-up ML Engine 805, extracted features 811.1-811.N from multiple UEs 1-N respectively may be received into an N channel input 822 and aggregated. Collectively, the aggregated features provide a set of features or inferences at an instant in time. In part, they provide a basis for making a beam blockage prediction. The shape of the features may change over time as the vehicles and pedestrians move, and other dynamic events occur.

In addition, the UEs may provide aggregated sensing coverage data 855 (e.g., a combination of various UE sensor parameters) as well as location information 856 such as the UEs' transmit and receive locations, angle of descent (AoD), and the like. In addition to the features from the aggregator (the N channel input 822), the sensing coverage aggregated data 855 and the location information 856 are provided to an inference model including one or more neural networks (NN) 826, used for the beam blockage predictions. The output of the neural networks 826 with the aggregated data includes feature predictions 828 such as, for example, predicted beam blockages, potential changes to beam/TX spatial precoders, potential changes to Tx FD/TD precoders, etc. This information can be used to modify precoders and to change communications to avoid or mitigate beam blockage occurrences.

Accordingly, it is apparent from FIG. 8 that, in order to effect the desired outcomes of adaptive sensing and sensor reconfiguration, an initial communication link is required to elicit service discovery of sensors and ML models, and subsequent session data in which desired parameters can be obtained. The adaptive sensing and sensor reconfiguration may be accomplished after the service discovery and session establishment has been completed, as further described below.

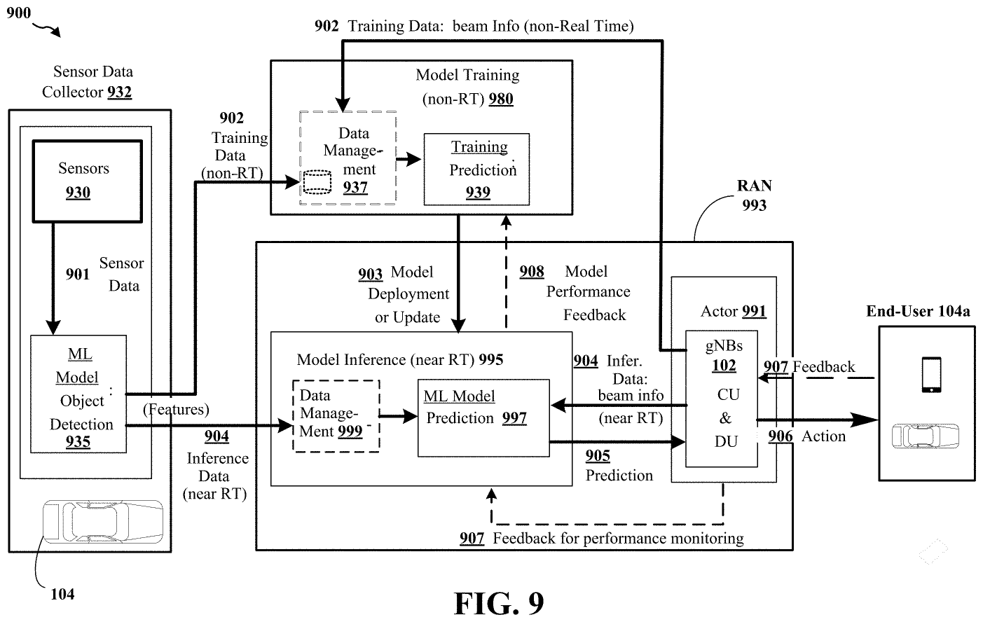

FIG. 9 is an example flow diagram 900 of adaptive ML training and inference functions for predicting beam blockages using a session based on the data gathered from the sensors and ML models of a UE. In an aspect, the diagram 900 includes sensor data collector 932, model training (non-RT) component 980, RAN 993, and end user 104a. RAN 993 may include model inference (near RT) component 995, and an actor 991 such as a gNB 102 or other network node. In this example, model training (non-RT) component 980 may be a component of, or serve as, non-RT RIC 415, 556, and model inference (near-RT) component 995 may be a component of, or serve as, near-RT RIC 425, 525. The sensor data may include a UE-based vehicle 104 that is equipped with sensors 930 and one or more ML models 935 used for object detection or feature extraction.

At 901 the raw sensor data may be provided to the ML model 935 where object detection and feature extraction can be performed. At 902, the non-RT training data is submitted from UE 104 to the non-RT model training component 980 and stored/processed at data management module 937. The data is thereafter transmitted in sequence to training module 939 where predictions may be made for the non-RT data. Also, at or about the same time (at 902), training data such as non-RT beam information may be transmitted from the actor 991 (the gNB or network node (CU, DU, etc.) in a disaggregated base station) to the data management module 937. The training data from the gNB/network node can be used with the training data from UE 104 to make predictions at training module 939.

Thereafter, at 903, the training component 939 of the non-RT module 980 transmits model deployment or update data based on the predictions to the near-RT model inference component 995. At 904, near-RT inference data from UE 104 is transmitted to the near-RT model inference component 995 and provided to a data management unit 999. Similarly, at 904, inference data including beam obstruction information (in near-RT) is passed from the actor 991 (e.g., the gNBs or one or more network nodes in the disaggregated configuration) to an ML model for predictions 997. At the near-RT model inference unit 995, the inference data at 999 may be provided to the ML prediction model 997 to make beam blockage predictions.

At 905, the beam blockage predictions are provided to the actor 991. The action determined to be responsive to the prediction may be forwarded to the various end users 104a at 906 (including UE 104). The end users that receive the action data thereupon may provide feedback to the actor 991 at 907. Meanwhile, the actor 991 may provide feedback to the near-RT unit 995 for performance monitoring. The near-RT unit 995 forwards model performance feedback at 908, if necessary, to the non-RT training model 980 for use in the non-RT training component 939.

It is noteworthy that, unlike the data sources 612 in the example of FIG. 6 in which training or inference data is internally collected, in this configuration, the data is externally collected from the sensors. Thus, instead of having a data reservoir which stores internally-collected data, the vehicle UEs 104 equipped with sensors act as data collectors. In this example, the actor 991 in FIG. 9 can be the gNB, for example, and the subject of the action may be instructing the UEs 104 to change beams or to use a different sensor, etc. In another aspect, the actor can be a network node—CU, DU, or some combination thereof—in an O-RAN.

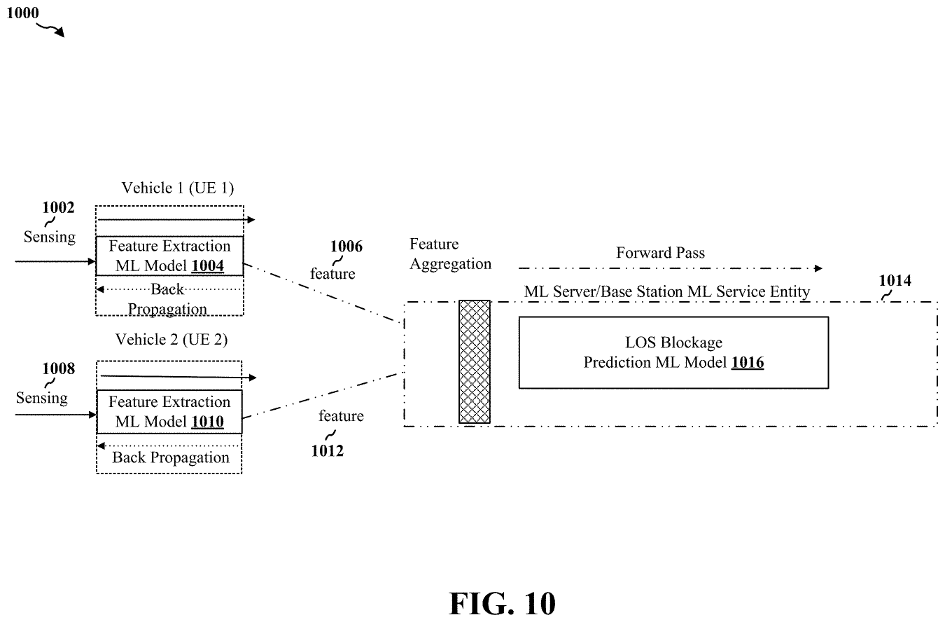

FIG. 10 is a conceptual diagram of an example 1000 where the training or the feature extraction models at a UE may be separated from the training or inference for prediction models at the ML service entity of the ML server or base station. UE 1 receives sensing data 1002 into a feature extraction model 1004, which extracts features 1006 from the sensing data. UE 2 may similarly receive sensing data 1008 into a feature extraction model 1010, which also extracts features 1012 from the sensing data. UE 1 and UE 2 may each perform back propagation to update weights of the model 1004 and model 1010 and improve feature extraction performance. After extracting the features, UE 1 and UE 2 may transmit these output features to an ML service entity 1014 to serve as inputs to a beam blockage prediction model 1016 for line of sight interference. The ML service entity 1014 may aggregate, for example through a summation or concatenation process, the features 1006, 1012 from the UEs and pass these aggregated features forward through the beam blockage prediction model 1016. As a result, the beam blockage prediction model may predict whether a beam blockage occurs from the aggregated sensing data from the UEs. Similarly, the ML service entity 1014 may perform back propagation to update weights of the model 1004 and model 1010 for feature extraction and improve beam blockage prediction performance. As illustrated in FIG. 10, the trainings or extraction conducted at the UEs and the training or inference conducted at the ML service entity 1014 are separated or de-coupled, as there is no exchange of training/inference parameters such as gradients between the devices.

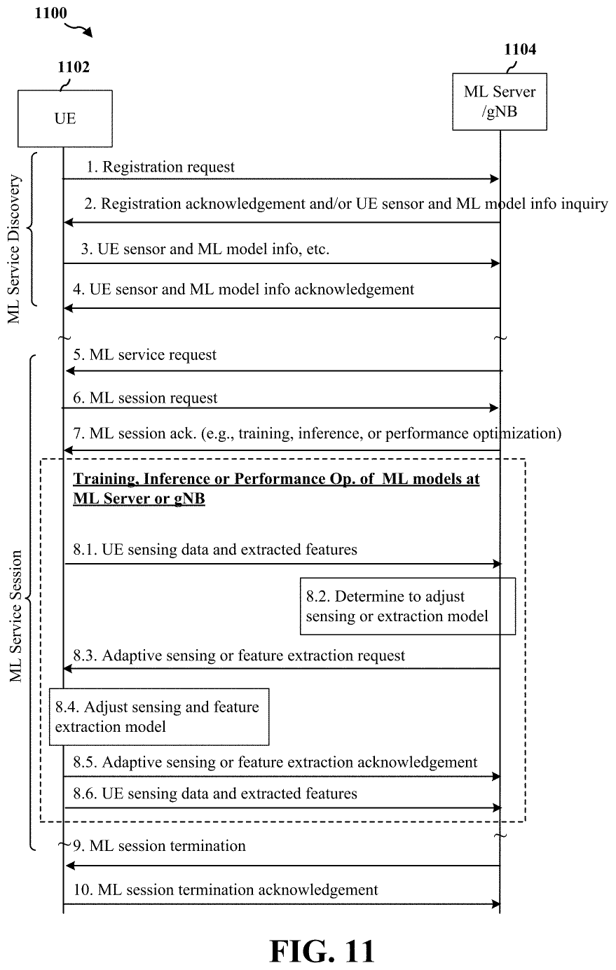

FIG. 11 is a flow diagram of an example communication flow 1100 between a UE 1102 and an ML service entity 1104 (e.g., often being within or part of an ML server or a base station (gNB, etc.), as indicated in the figure) in which the ML service entity may request adaptive sensing and feature extraction for prediction tasks (e.g., line-of-sight blockage prediction) to better support separated ML training, inference and/or performance optimization such as illustrated in FIG. 10. The adaptive sensing and feature extraction may occur after an ML service discovery process is performed and an ML service session is established between the UE and the ML service entity. For example, at 1, the UE 1102 may send a registration request to the ML service entity 1104. At 2, the ML service entity 1104 may acknowledge the request and inquire as to the UE's sensor information and ML model information. Then at 3, the UE 1102 may provide its sensor and model information, which the ML service entity may acknowledge at 4. Following this discovery process, at 5, the ML service entity 1104 may provide an ML service request to the UE 1102. In response to the ML service request, at 6, the UE 1102 may send an ML session request to the ML service entity 1104, which may acknowledge the session request at 7. Following this session establishment process, training, inference or performance optimization of ML models at the ML service entity may begin.

In one approach, at 8.1, the UE 1102 may provide training or inference data (extracted features) to an ML model at the ML service entity 1104 as previously described. However, the UE may also include multiple ML models that each perform feature extraction tasks (e.g., detecting OBBs). Although the multiple ML models may each perform the same tasks, they may have different tradeoffs between inference time and model accuracy. For example, for the task of OBB detection, the UE may include multiple models with their own computation speeds, detection accuracy, and output format. Some of these models may be more complex and thus achieve higher accuracy, but often incur longer inference times, while others may be less complex and thus achieve lower accuracy, but incur shorter extraction times.

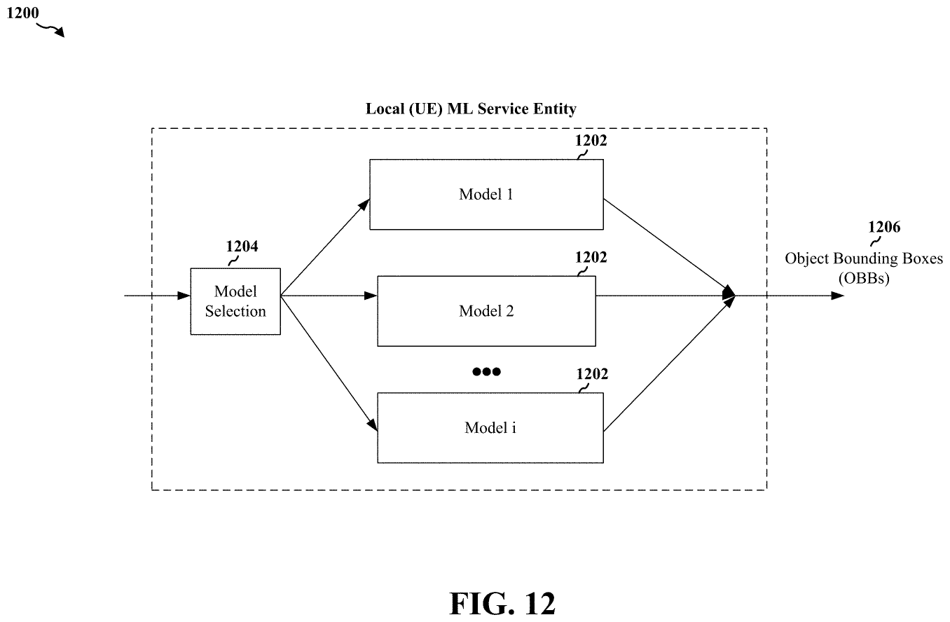

As an example, FIG. 12 is a conceptual diagram illustrating an example 1200 of an ML service entity 840 at a UE including multiple feature extraction models 1202. For example, in response to a request from the ML service entity 1104 at the BS in FIG. 11, the UE may perform a model selection 1204 between any one (or more) of the i models configured at the UE for extracting OBBs 1206. Each of the models 1202 may have different computation times and detection accuracies. For example, some of the models 1202 may be more complex than other models (e.g., have longer computation timing, include different amounts of data collection, and the like), and some of the models 1202 may have different performance than other models (e.g., have less accuracy, more false alarms or misdetection of OBBs, and the like). The different complexity and performance of these models 1202 may be a result of different characteristics of these models as well. For instance, some of the models 1202 may be a standalone architectural framework such as MLP, CNN, or RNN, while others of the models 1202 may be a combination of the aforementioned architectural frameworks. Moreover, models 1202 may have different numbers of layers, kernel sizes, activation functions used in different layers, weights of different layers, and the like.

Referring back to FIG. 11, the ML service entity 1104 may request the UE 1102 to switch between the different models illustrated in FIG. 12 according to the ML service entity 1104's training or inference need, which may depend on a state of UE 1102. The state of the UE 1102 may encompass, for example, a mobility status of the UE (e.g., a speed of the UE, a moving direction of the UE, or position of the UE relative to other UEs, pedestrians or buildings, and the like), a number of UEs in the UE's area or location, a computational or data processing capability of the UE, an amount of uplink traffic sharing the UE's bandwidth or the uplink traffic load of the network including the UE, and the like. As an example, if the UE 1102 is moving more slowly, is within an environment having a small number of dynamic objects (e.g., moving vehicles or pedestrians), or the like, the training or inference need may be different than in the case where the UE 1102 is moving more quickly, is within an environment having a larger number of dynamic objects, and the like. In the latter case, the ML service entity 1104 may determine a need to receive extracted features from the UE 1102 at a faster rate than in the former case, albeit with a tradeoff to accuracy, in order to more quickly predict beam blockages in the fast and dense environment of the UE 1102. On the other hand, in the former case, if the ML service entity 1104 determines the beam blockage predictions it currently makes are not sufficiently accurate, the ML service entity 1104 may determine a need to receive extracted features from the UE 1102 more accurately than in the latter case, albeit with a tradeoff to speed, in order to more accurately predict beam blockages in the slow and less populated environment of the UE.

Thus, in response to receiving the training or extracted features (e.g., OBBs 1206) from the UE 1102 at 8.1, at 8.2, the ML service entity 1104 may determine and request the UE 1102 to use either a slower but higher accuracy model (e.g., EfficientNet) or a faster but lower accuracy model (e.g., SSD MobileNet). The ML service entity 1104 may send a request to this effect at 8.3. For example, if the ML service entity 1104 is informed of the UE's individual model parameters of models 1202 during the discovery or session establishment process (at steps 1-7 above in FIG. 11), the ML service entity 1104 may request the UE 1102 to switch to an expressly indicated model in the request based the UE state as previously described. Alternatively, the ML service entity 1104 may request the UE 1102 to switch to a different model according to the UE's own determination based on its UE state, similar to how the ML service entity 1104 makes the determination as previously described.

In response to the request, at 8.4, the ML service entity 840 (in FIG. 8) at the UE 1102 may adapt its sensing and extraction model accordingly. For example, the UE 1102 may perform model selection 1204 of a different one of its models 1202 which output OBBs 1206. Afterwards, the UE 1102 may provide an acknowledgment of the request to the ML service entity 1104 at 8.5, and transmit new sensing data and extracted features (e.g., OBBs 1206 from the new model) after the adaptation at 8.6. As a result, the ML service entity 1104 may input this new data into its beam blockage prediction model to make more accurate or faster beam blockage predictions (depending on the UE model selected). The session may continue until the ML service entity 1104 eventually sends a session termination notice at 9 and the UE acknowledges the session termination at 10.

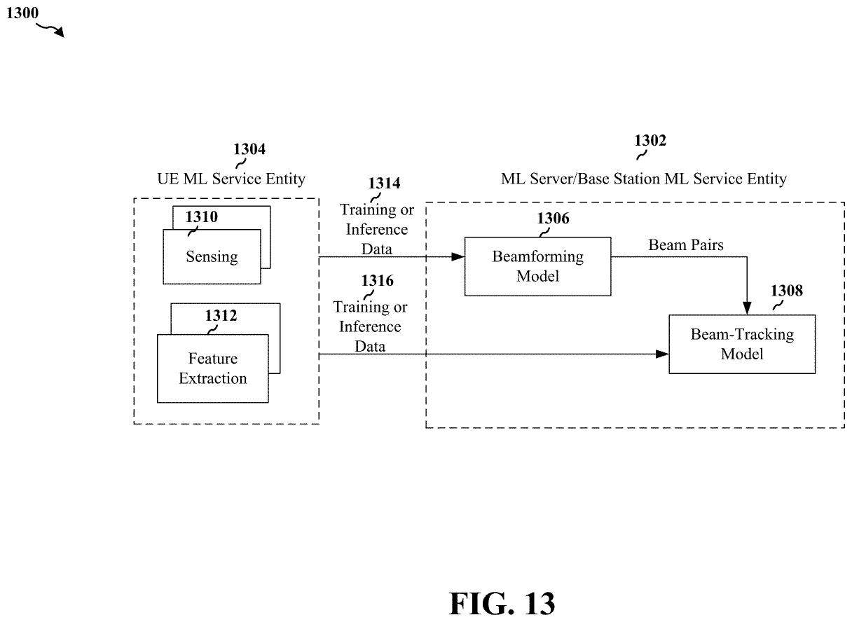

FIG. 13 is a conceptual diagram 1300 illustrating another approach for adaptive sensing and feature extraction in which an ML service entity 1302 at the ML server or gNB includes multiple ML models. In this approach, an ML service entity 1304 of a UE may provide training or extracted features to an ML model at the ML service entity 1302 as previously described in FIG. 11 at 8.1. However, the ML service entity 1302 here may include multiple ML models which perform different functions. For example, one of the models may be a beamforming model 1306 which predicts K best Tx beams to beam sweep, while another one of the models may be a beam tracking or beam refinement model 1308 which predicts K best refined Tx beams from the Tx/Rx beam pairs including the K best Tx beams. The ML service entity 1302 may apply these models to more efficiently perform beam management. For example, based on sensing information provided by the UE as well as a state of the UE, the beamforming model 1306 may predict a certain angular area in which numerous UEs may be positioned, and the base station may more frequently perform beam sweeps for beam training in that area accordingly.

While the example of FIG. 13 describes the ML service entity's models 1306, 1308 as being related to beam management, it should be understood that in other examples, the ML service entity's models may not be limited to beam management. For instance, one or more of the ML service entity's models 1306, 1308 may predict LOS beam blockages between a base station and the UE, predict best beams for communication with a UE, perform beam management (beamforming training or refinement), optimally schedule resources to the UE, balance current traffic loads, and the like, in response to sensor data 1310 or extracted features 1312 from UEs. Moreover, any one of the ML service entity's models may have a relationship or association with, or be triggered in response to data from, any other one of the ML service entity's models. For example, as illustrated in the example of FIG. 13, the beam-tracking model may be triggered to predict best refined beams in response to the beam pairs predicted by the beamforming model.

Furthermore, the sensor data 1310 or extracted features 1312 which serve as training or inference data 1314 for one ML model of the ML service entity 1302 may be different than the sensor data 1310 or extracted features 1312 which serve as training or inference data 1316 for another ML model of the ML service entity 1302. For example, if the ML service entity 1302 is currently applying the beamforming model 1306 to make beamforming predictions, the ML service entity 1302 may request the UE to switch to one of its models 1202 in FIG. 12 and provide training or inference data 1314. The training or inference data 1314 may be, for example, OBBs indicating potential UEs in an area within the UE's sensor's field of view. Alternatively, if the ML service entity 1302 is currently applying the beam refinement model 1308 to make beam refinement predictions, the ML service entity 1302 may request the UE to switch to a different one of its models 1202 in FIG. 12 and provide different training or inference data 1316 accordingly. The training or inference data 1316 may be, for example, OBBs indicating potential UEs with finer sensor resolution than that of training or inference data 1314, or even the same OBBs as in training or inference data 1314 but at a faster rate. Thus, it should be understood that the models 1202 at the UE may not only be configured to output the same extracted features with different computation speeds or detection accuracies as previously described, but alternatively may be configured to output different extracted features for input to different ML models of the ML service entity 1302. For instance, the ML service entity 1302 may instruct the UE not only to switch to a different one of its models 1202, but also to reconfigure one or more of its sensors (e.g., the field of view, etc.) to provide different sensor data to the new model 1202 to extract different OBBs accordingly.

Additionally, the ML service entity 1302 may request the UE to switch to a different one of its models in FIG. 12 based on a performance of an ML model of the ML service entity 1302. For example, if the ML service entity 1302 determines, based on the beam measurements collected by the base station or reported by end users, that the performance (prediction accuracy) of beamforming model 1306 or beam refinement model 1308 is unacceptably low or below a certain criteria, the ML service entity 1302 may retrain its model or switch to a different model. Alternatively or additionally, the ML service entity 1302 may request the UE to switch to a different one of its models 1202 to provide slower or more accurate OBBs based on the UE state. For example, if the UE is moving slowly or is in an environment with a small number of dynamic objects, the ML service entity may request the UE to switch to a slower but more accurate model and thereby provide slower but more accurate extracted features for the ML service entity 1302. In turn, the ML service entity 1302 may input this more accurate sensing information in its models and more accurately predict beam blockages, best beams, and the like, resulting in better model performance.

Referring back to FIG. 11 at 8.2, the ML service entity 1104 may determine and request the UE 1102 to provide different sensor data or extracted features (from a different ML model of the UE) for the different ML models of the ML service entity 1104. For example, when the ML service entity 1104 is performing beam forming using the ML beamforming model based on training or inference data provided by one model of the UE 1102, the ML service entity 1104 may determine at 8.2 to perform beam refinement using the ML beam refinement model. As a result, at 8.3, the ML service entity 1104 may request the UE 1102 to switch to a different model to provide different data to the ML service entity 1104 to serve as input for the ML beam refinement model. In another example, when the ML service entity 1104 is performing beam forming using the ML beamforming model based on training or inference data provided by one model of the UE 1102, or beam refinement using the ML beam refinement model based on different training or inference data provided by another model of the UE 1102, the ML service entity 1104 may determine at 8.2 that the performance of the beamforming or beam refinement model is not sufficient. As a result, at 8.3, the ML service entity 1104 may request the UE 1102 to switch to a different model to provide more accurate data to the ML service entity 1104 to improve the accuracy and thus performance of its ML models. In response to the request, at 8.4, the ML service entity 1104 at the UE 1102 may adapt its sensing and extraction model accordingly, provide an acknowledgment of the request at 8.5, and transmit new sensing data and extracted features after the adaptation at 8.6. As a result, the ML service entity 1104 may input this new data into its beamforming or beam refinement model to make more accurate predictions (depending on the UE model selected). As a result of the higher accuracy, potential beam blockages that otherwise would have been missed from inaccurate predictions may be avoided.

In another approach for adaptive sensing and feature extraction, the UE may be configured to communicate a confidence level for each feature extraction. For instance, the UE 1102 similarly provide training or inference data to an ML model at the ML service entity 1104 as previously described in FIG. 11 at 8.1 or 8.6, but additionally include a confidence level indicating an accuracy associated with the data provided. Alternatively (or additionally), at 8.2, the ML service entity 1104 may determine a confidence level from the data provided by the UE 1102, either from the message including the data itself or from the ML service entity's own interpretation of a confidence level.

In one example, if a sensor of the UE has a severely occluded field of view, then the point cloud represented by the data may not be fully informative or misleading, and so the UE or ML server/gNB may classify that data with a low confidence level. The UE or ML server/gNB may detect such occlusion to a vehicular sensor's field of view, and thus determine the confidence level associated with the data from the point cloud encompassed under that field of view, from the previous time instants when other data associated with that sensor was provided. Referring to FIG. 11, in response to determining the low accuracy of this data accordingly, at 8.3, the ML service entity 1104 may request the UE 1102 to adapt its feature extraction to these occlusions. For example, at 8.4, the UE 1102 may reconfigure its sensor field of view to avoid the occlusion, or the UE may switch to a more accurate model which results in feature data having higher confidence levels.

In another example, the ML service entity 1104 may determine and request the UE 1102 to apply a feature extraction model that infers one or more confidence levels. For example, referring again to FIG. 11, the ML service entity 1104 may determine at 8.2 to provide a request at 8.3 to the UE 1102 to switch to one of its multiple models 1202 of FIG. 12 which has a capability of inferring a confidence level for its OBBs 1206 or other extracted features. The confidence level may for example be a flag or bit indicating whether an OBB is accurately detected to bound an object or not. In another example, the model 1202 may infer the distribution curves for the dimensions of the OBB, and the confidence level may indicate the accuracy of an inferred dimension of the OBB based on the distribution curves. In another example, the model 1202 may infer bounding boxes along with their dimensions and directions, while allowing for a greater margin of error along dimensions and directions carrying the greatest measure of uncertainty, and the confidence level may indicate the margin of error of these dimensions or directions. In response to receiving the request, at 8.4, the UE 1102 may determine to switch to one of its ML models which have the requested confidence level capability, and adapt its sensing and feature extraction accordingly as previously described.

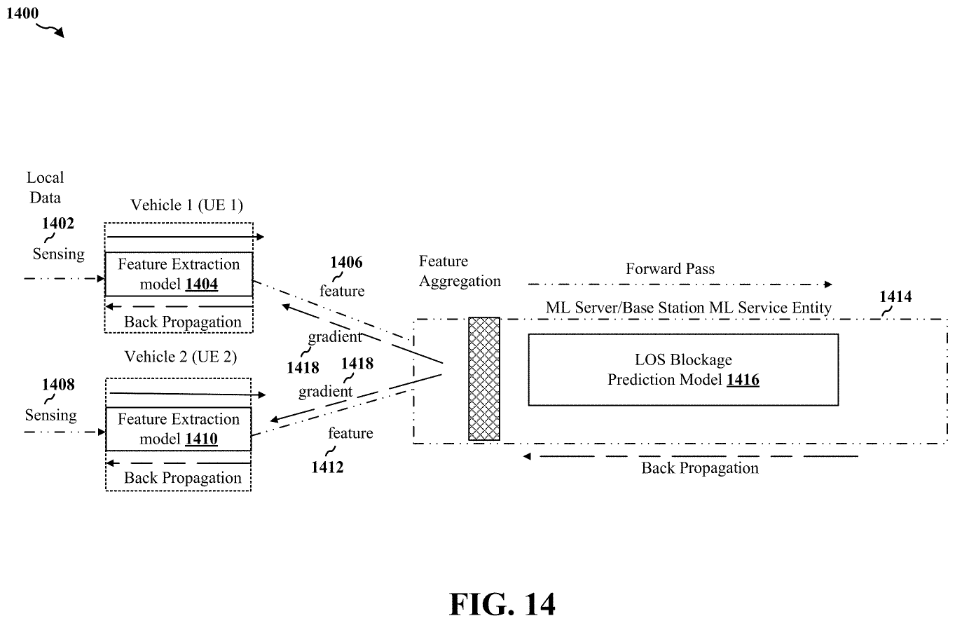

FIG. 14 is a conceptual diagram of an example 1400 where the training or feature extraction at a UE may be joined or associated with the training or inference for prediction models at the ML service entity of the ML server or base station. Similar to the example of FIG. 10, UE 1 receives sensing data 1402 into a local feature extraction model 1404, which extracts features 1406 from the sensing data. UE 2 may similarly receive sensing data 1408 into a local feature extraction model 1410, which also extracts features 1412 from the sensing data. UE 1 and UE 2 may also each perform back propagation to update weights of the models 1404, 1410 and improve feature extraction performance. After extracting the features 1406, 1412 in a forward pass, UE 1 and UE 2 may transmit these output features to an ML service entity 1414 to serve as inputs to a beam blockage prediction model 1416 for line of sight interference. The ML service entity 1414 may aggregate, for example through a summation or concatenation process, the features from the UEs and pass these aggregated features forward through the beam blockage prediction model. As a result, the beam blockage prediction model 1416 may predict whether a beam blockage occurs from the aggregated sensing data from the UEs. Similarly, the ML service entity 1414 may perform back propagation to update weights of the model and improve beam blockage prediction performance.

Moreover, as illustrated in FIG. 14 and unlike the example of FIG. 10, the ML service entity 1414 may broadcast the aggregated, gradient information 1418 (or other aggregated back propagated output from the beam blockage prediction model 1416) to the UEs. Upon receiving the aggregated performance characteristics from the ML service entity 1414, each of the UEs may apply these characteristics to their own back propagation in their local feature extraction models 1404, 1410 and adaptively adjust their sensing and feature extraction accordingly. For instance, each of the UEs may update the weights of their feature extraction models based not only on their local gradients but also the aggregated gradients 1418 received from the ML server or gNB.

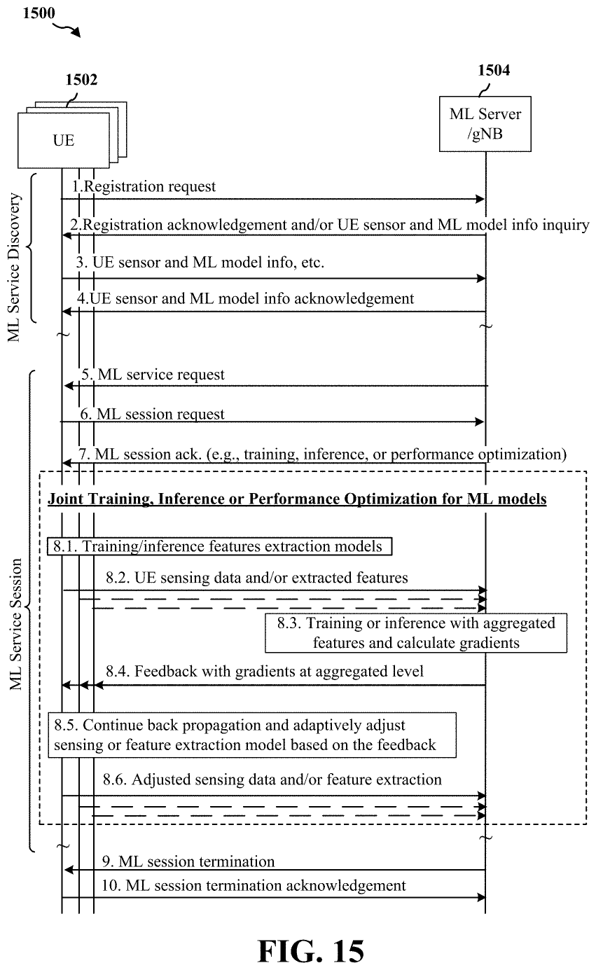

FIG. 15 is a flow diagram of an example communication flow 1500 between a UE 1502 and an ML service entity 1504 in which the ML service entity may request adaptive sensing and feature extraction for prediction tasks (e.g., line-of-sight blockage prediction) to better support joint ML training, inference and/or performance optimization such as illustrated in FIG. 14. Similar to the example of FIG. 11, the adaptive sensing and feature extraction may occur after an ML service discovery process is performed and an ML service session is established between the UE 1502 and the ML service entity 1504. For example, at 1, the UE 1502 may send a registration request to the ML service entity 1504. At 2, the ML service entity 1504 may acknowledge the request and inquire as to the UE's sensor information and ML model information. Then at 3, the UE 1502 may provide its sensor and model information, which the ML service entity 1504 may acknowledge at 4. Following this discovery process, at 5, the ML service entity 1504 may provide an ML service request to the UE 1502. In response to the ML service request, at 6, the UE 1502 may send an ML session request to the ML service entity 1504, which may acknowledge the session request at 7. Following this session establishment process, training, inference or performance optimization of ML models at the ML service entity 1504 may begin.

Initially, at 8.1, the UE 1502 may train its local feature extraction model, and at 8.2, the UE 1502 may provide sensor data or inference data to the beam blockage prediction model at the ML service entity 1504 as previously described in FIG. 14. Then, at 8.3, the ML service entity 1504 aggregates the data or features received from the UE 1502 with the data or features received from other UEs, and inputs this aggregated data into its beam blockage prediction model for the forward pass. The ML service entity 1504 may also calculate the gradients and back propagate these characteristics through the beam blockage prediction model to update the model weights and improve beam blockage performance. Then, at 8.4, the ML service entity 1504 broadcasts these aggregated characteristics or back propagation output to the UE 1502. Upon receiving this information, at 8.5, the UE 1502 may apply these aggregated gradients to its own back propagation through its local feature extraction model, and adaptively adjust the model accordingly. Afterwards, at 8.6, the UE 1502 may provide adjusted sensor data or inference data from the adjusted model to the ML service entity 1504 accordingly. As a result, the ML service entity 1504 may input this new data into its beam blockage prediction model to continue to make beam blockage predictions. The session may continue until the ML service entity 1504 eventually sends a session termination notice at 9 and the UE 1502 acknowledges the session termination at 10.

In addition to exchanging control messages with the UE for adaptive sensing and feature extraction, the ML service entity of the ML server or base station may exchange adaptive sensor configuration or reconfiguration messages. The messages may include parameters for configuring or reconfiguring the UE's sensors. Referring to FIG. 8, these messages may be exchanged between the control or management function of the UE's ML service entity 840 and the control or management function at the ML service entity 830 of the gNB or ML server collocated with the gNB or located near the gNB (e.g., cloud or edge server). Moreover, the messages may be exchanged during one or more procedures such as ML service discovery and ML session establishment, model training, model inference, and/or model performance optimization.

In one approach, the gNB/ML server may initiate or trigger adaptive sensor configuration or reconfiguration by sending a configuration or reconfiguration message to the UE including configured parameters based on one or multiple factors. These factors may relate to ML service training requirements, ML service inference requirements, ML service performance requirements, network traffic load, and a number of UEs in the area. In one example, with respect to ML service training, the UE may have unobstructed or obstructed views. If the UE has unobstructed views, the gNB/ML server may configure the UE to combine all RADAR point clouds from its various sensors and transmit a joint feature map to the gNB/ML server. If the UE has obstructed views, for example, from its front RADAR that can complement the left window radar of an adjacent vehicle UE, the gNB/ML server may configure the UE to return the feature map from that front RADAR point cloud separately or perform some other complementary configuration. In another example, with respect to ML service inferences, the UE may have occlusions in a previously declared field of view. For example, if a UE which previously had a mostly unobstructed RADAR has an occlusion (or an approaching occlusion) to the RADAR, the gNB/ML server may instruct the UE to not use the obstructed RADAR and separately instruct an adjacent vehicle UE to start using its unobstructed RADAR. In a further example, with respect to ML performance requirements, performance degradation may occur of the beam blockage prediction model due to poor resolution of the data or high mobility of the UEs. Thus, the gNB/ML server may configure the UEs sensors to adapt accordingly to improve sensor resolution or account for UE mobility. In another example, if the gNB/ML server determines a high network traffic load, the gNB/ML server may configure the UE to lower its RADAR measurement update rate, or to lower the resolution and frame rate of its camera. In an additional example, if the number of UEs in the area of the UE is high, the gNB/ML server may configure the UE to similarly lower its RADAR measurement update rate.

In another approach, the UE may initiate or trigger adaptive sensor configuration or reconfiguration by sending a message to request or notice a configuration update or reconfiguration to the gNB/ML server including preferred or updated parameters based on one or multiple factors. These factors may relate to vehicle sensor settings and configurations, sensor availability, sensor selection, location changes, speed changes, direction changes, radio link quality with the gNB/ML server, a UE vehicle advanced driver-assistance system (ADAS), or UE sensor occlusion. In one example related to vehicle sensor settings and configurations, the UE may determine to change its FoV, range, or measurement update rate of its sensors in order to gain information of an area of interest. In another example related to sensor availability, upon determining that a sensor such as a rear RADAR is not actively used for an ADAS task, the UE may determine to reconfigure the sensor to serve the sensing need of the ML server/gNB. In another example related to sensor selections, the UE may determine to select one or more specific sensors, such as its front RADAR only or its front mounted camera only, based on the sensing needs of the ML server or gNB. In another example related to location changes, the UE may determine to change its FoV and range in response to determining that the UE is located on a highway or at an intersection. In another example related to speed changes, the UE may determine to change its measurement update rate or change its FoV in response to determining a speed up or a speed down. In another example related to direction changes, the UE may determine to use a different set of sensors for beam blockage prediction in response to determining a change in its direction. In another example related to radio link quality with the gNB/ML server, the UE may determine to change its data rate or latency associated with communicating its data to the gNB/ML server, for example, by lowering the RADAR measurement update rate or the resolution or frame rate of the camera when the connection is poor, while increasing the RADAR measurement update rate or the resolution or the frame rate of the camera when the connection is strong. In another example related to the UE's vehicle ADAS, the UE may determine to reconfigure, for example, the FoV of a RADAR which is previously configured to serve the gNB/ML server's training, inference, or ML performance optimization needs, in order to serve the vehicle's ADAS need, by preemptively overriding the previous setting of the FoV and sending the gNB/ML server a reconfiguration update message including its reconfigured parameters for its RADAR. In a further example related to UE sensor occlusion, the UE may determine to adapt its sensing due to occlusions in a previously declared FoV, for example, if the UE which previously had a mostly unobstructed RADAR has an occlusion (or approaching occlusion) to the RADAR, the UE can preemptively reconfigure the FoV or switch to another RADAR having an unobstructed view and send the gNB/ML server a reconfiguration update message including reconfigured parameters accordingly.

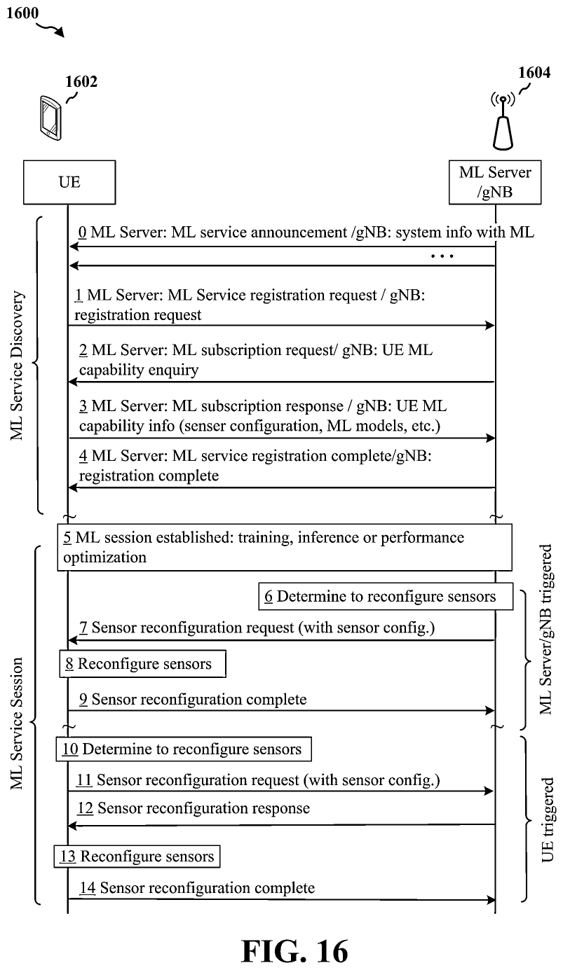

FIG. 16 is a flow diagram of an example communication flow 1600 between a UE 1602 and an ML service entity 1604 in which the ML service entity or the UE may trigger sensor configuration or reconfiguration for prediction tasks (e.g., line-of-sight blockage prediction) to better support ML training, inference and/or performance optimization. For example, the UE may include configurable sensors such as RADAR sensors or cameras including reconfigurable parameters including, but not limited to, FoV, orientation range, resolution or image resolution, update rate or frame rate, and the like. The ML service entity 1604 at the ML server or gNB may manage the configuration or reconfiguration of these parameters of the UE's sensors according to the process illustrated in FIG. 16.

Initially, sensor configuration may occur during the ML service discovery or ML session establishment phase. During ML service discovery, initially at 0, the ML server may send an ML service announcement, or the gNB may send system information with ML learning capability, to the UE 1602. At 1, the UE 1602 may send an ML service registration request to the ML server or a registration request to the gNB. At 2, the ML server may send the UE 1602 an ML subscription request or the gNB may send the UE 1602 an ML capability enquiry. Then at 3, the UE 1602 may send the ML server an ML subscription response or the gNB a UE ML capability information message indicating its ML subscription or capability information (e.g., its on-board sensor configuration, supported ML models, reconfigurable parameters, and the like). For example, the UE 1602 may indicate a list of RADAR sensor/detector reconfigurable parameters such as FoV, orientation, range, resolution, update rate, and the like, as well as other RADAR sensor parameters including but not limited to sensor identification (e.g., number of RADAR sensors and associated IDs), sensor mounting on the vehicle (e.g., positions relative to the center of the ego vehicle and the mounting rotation angle [roll, pitch, yaw]), the detector configuration (e.g., angular field of view, range limit (min and max detection range), range rate limit (min and max range rate), detection probability, false alarm rate, range resolution, angle central band frequency, and the like), and the measurement resolution and bias (e.g., azimuth, elevation, range, range rate resolutions, and the like). Similarly, the UE 1602 may indicate a list of camera sensor/detector reconfigurable parameters such as FoV, image resolution, frame rate, and the like, as well as other camera sensor parameters including but not limited to sensor identification (e.g., number of camera sensors and associated IDs), sensor mounting within vehicle (e.g., positions relative to the center of the ego vehicle and the mounting rotation angle [roll, pitch, yaw]), detector configuration (e.g., camera image size, camera focal length, optical center, radial and tangential distortion coefficients, and the like). Afterwards, at 4, the ML server may send an ML service registration complete message or the gNB may send a registration complete message.

Following completion of session discovery and indication of the reconfigurable sensor parameters, at 5, the UE 1602 and ML server/gNB may establish a session between the devices for training, inference or performance optimization. Afterwards, either the gNB/ML server or the UE may trigger adaptive sensor reconfiguration. In one example where the gNB/ML server triggers adaptive sensor reconfiguration during a training, inference or performance optimization procedure, at 6, the gNB/ML server determines the reconfiguration parameters based on the criteria or factors described previously, and then at 7, the gNB/ML server sends the UE a sensor reconfiguration request indicating the sensor parameters to be reconfigured. The factors may, for example, relate to ML service training requirements, ML service inference requirements, ML service performance requirements, network traffic load, or a number of UEs in the area. In response to the request, at 8, the UE 1602 may reconfigure its on-board sensors accordingly and, at 9, the UE may provide a confirmation or complete message to the ML server or gNB.

In another example where the UE 1602 triggers adaptive sensor reconfiguration, at 10, the UE may determine the reconfiguration parameters for its sensors based on the different criteria or factors described previously, and at 11, the UE may send the gNB/ML server a sensor reconfiguration request indicating the sensor parameters to be reconfigured. These factors may, for example, relate to vehicle sensor settings and configurations, sensor availability, sensor selection, location changes, speed changes, direction changes, radio link quality with the gNB/ML server, a UE vehicle advanced driver-assistance system (ADAS), or UE sensor occlusion. If at 12, the gNB/ML server responds with an indication allowing the reconfiguration, then at 13, the UE reconfigures its on-board sensors accordingly, and at 14, the UE may provide a confirmation or complete message to the ML server or gNB. Alternatively, if at 12, the gNB/ML server responds with an indication denying the reconfiguration, then the UE 1602 may refrain from performing steps 13 and 14. Alternatively, if at 12, the gNB/ML server responds with an indication modifying the reconfiguration, then at 13, UE may reconfigure its on-board sensors based on the modification, and at 14, the UE may provide a confirmation or complete message to the ML server or gNB.

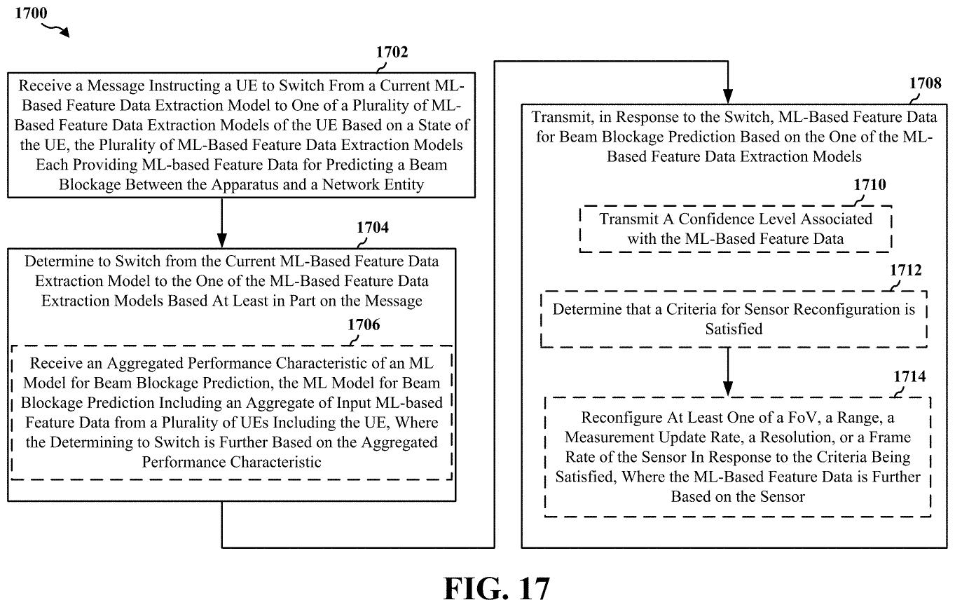

FIG. 17 is a flowchart 1700 of a method of wireless communication. The method may be performed by a UE (e.g., the UE 104, 104a, 350, 704a, 704b, 704c, 704d, 1102, 1502, 1602; the apparatus 1902). Optional aspects are illustrated in dashed lines. The method allows a UE to switch between its ML-based feature data extraction models (and optionally reconfigure its sensors) in response to an adaptive configuration from the base station in order to provide feature data of dynamic or mobile potential LOS obstacles for improved beam blockage prediction performance at the network entity or node. The network entity or node may be for example, an aggregated or disaggregated base station, an ML server co-located with or located near an aggregated or disaggregated base station, a component of a disaggregated base station (e.g., a near-RT RIC, a non-RT RIC, a CU, DU, or RU, or other disaggregated base station component), an ML service entity in an aggregated base station, an ML service entity in a component of a disaggregated base station, an ML service entity in an ML server co-located with or located near such base station, or other network entity or node.

At 1702, the UE may receive a message instructing the UE to switch from a current ML-based feature data extraction model to one of a plurality of ML-based feature data extraction models of the UE based on a state of the UE. For example, 1702 may be performed by configuration reception component 1940. The plurality of ML-based feature data extraction models each provide ML-based feature data for predicting a beam blockage between the UE and the network entity or node. For instance, referring to FIGS. 11 and 12, the UE 1102 (e.g., the Rx processor 356 of UE 350, or the ML service of the UE) may receive from the network node (for example, the ML service entity 1104 of the base station or ML server) at 8.3 a request for the UE to switch from one of its models 1202 to another one of its models 1202 for extracting OBBs 1206 or other feature data from point clouds, images, or other sensor data. This feature data may in turn be applied for predicting beam blockages between the UE and the network node. The request may be received based on a state of the UE. The state of the UE may comprise at least one of: a mobility status of the apparatus, a number of UEs in an area of the UE, a data processing capability of the UE, an amount of uplink traffic sharing a bandwidth of the UE, or an uplink traffic load of a network including the UE. For example, the state of the UE may be a mobility status of the UE (e.g., a speed of the UE, a moving direction of the UE, or position of the UE relative to other UEs, pedestrians or buildings, and the like), a number of UEs in the UE's area or location, a computational or data processing capability of the UE, an amount of uplink traffic sharing the UE's bandwidth or the uplink traffic load of the network including the UE, and the like. For instance, if the UE has initially been applying one of its feature data extraction models at a particular UE speed, location, network traffic load, etc., but later the UE has increased its speed, changed its location, experienced an increase in uplink traffic, or some other UE state change has occurred, the request may indicate the UE to switch from that model to a different model which may output OBBs or other feature data at a faster rate albeit with a tradeoff to accuracy, in order for the ML service entity 1104 to more quickly predict beam blockages.

In one example, the message at 1702 may be indicative of a performance of at least one of a plurality of ML models for beam management. For example, referring to FIGS. 11-13, if the ML service entity 1104 determines, based on beam measurements collected by the base station or reported by end users, that the performance (prediction accuracy) of beamforming model 1306 or beam refinement model 1308 is unacceptably low or below a certain criteria, the ML service entity may request (in the configuration/request at 8.3) the UE to switch to a different one of its models 1202 to provide slower or more accurate OBBs 1206. In turn, the ML service entity 1104 may input this more accurate sensing information in its models and more accurately predict beam blockages, best beams, and the like, resulting in better model performance.

In another example, the message further comprises instructions for the UE to transmit different ML-based feature data for different ML models for beam management. For example, referring to FIGS. 11-13, if the ML service entity 1104 is currently applying the beamforming model 1306 to make beamforming predictions, the ML service entity may request (in the message at 8.3) the UE 1102 to switch to one of its models 1202 in FIG. 12 and provide training or inference data 1314. The training or inference data 1314 may be, for example, OBBs indicating potential UEs in an area within the UE's sensor's field of view. Alternatively, if the ML service entity 1104 is currently applying the beam refinement model 1308 to make beam refinement predictions, the ML service entity may request (in the message at 8.3) the UE 1102 to switch to a different one of its models 1202 in FIG. 12 and provide different training or inference data 1316 accordingly. The training or inference data 1316 may be, for example, OBBs indicating potential UEs with finer sensor resolution than that of training or inference data 1314, or even the same OBBs as in training or inference data 1314 but at a faster rate.

At 1704, the UE may determine to switch from the current ML-based feature data extraction model to the one of the ML-based feature data extraction models in response to the message at 1702. For example, 1704 may be performed by model switch determination component 1942. For example, referring to FIGS. 11 and 12, at 8.4, the UE 1102 (e.g., the controller/processor 359 of UE 350, or the ML service at the UE) may determine to adapt its sensing and extraction model according to the message received at 8.3. For example, if the ML service entity 1104 requests the UE at 8.3 to switch to an expressly indicated model in the request based the UE state as previously described, then the UE 1102 may perform model selection 1204 to select a different one of its models 1202 which output OBBs 1206 as expressly indicated in the request (e.g., model 1-i in FIG. 12). Alternatively, if the ML service entity 1104 requests the UE at 8.3 to switch to a different model according to the UE's own determination (without an express indication of the model), the UE may determine which model to select based on the UE state. For instance, if the request at 8.3 indicates the ML service entity requests the UE to provide extracted features at a faster rate, the UE may determine to select a less complex one of its models 1202 during model selection 1204, while if the ML service entity requests the UE to provide more accurate extracted features, the UE may determine to select a more complex one of its models 1202 during model selection 1204.

In one example, the ML-based feature data extraction models may include different computation speeds and different detection accuracies. For example, some of the models 1202 may be more complex than other models (e.g., have longer computation timing, include different amounts of data collection, and the like), and some of the models 1202 may have different performance than other models (e.g., have less accuracy, more false alarms or misdetection of OBBs, and the like). The different complexity and performance of these models 1202 may be a result of different characteristics of these models as well. For instance, some of the models 1202 may be a standalone architectural framework such as MLP, CNN, or RNN, while others of the models 1202 may be a combination of the aforementioned architectural frameworks. Moreover, models 1202 may have different numbers of layers, kernel sizes, activation functions used in different layers, weights of different layers, and the like.

In one example, the determining at 1704 to switch to the second one of the ML-based feature data extraction models is independent of an aggregated performance characteristic of an ML model for beam blockage prediction of the network node. In this example, the ML model for beam blockage prediction may include an aggregate of input ML-based feature data from a plurality of UEs including the UE. Alternatively, in another example, at 1706, the UE may receive an aggregated performance characteristic of an ML model for beam blockage prediction. For example, 1706 may be performed by performance characteristic reception component 1944. In this alternative example, the ML model for beam blockage prediction may similarly include an aggregate of input ML-based feature data from a plurality of UEs including the UE. However in this example, the determining at 1704 to switch to the second one of the ML-based feature data extraction models may be based on the aggregated performance characteristic.

For instance, FIGS. 10 and 14 illustrate examples where the ML service entity 1014, 1414 includes a beam blockage prediction model 1016, 1416 (see also 826, 939 or 997 in FIGS. 8 and 9) which receives aggregated, extracted features 1006, 1012, 1406, 1412 from a plurality of UEs (UE 1 and UE 2 in this example), predicts whether a beam blockage occurs from the aggregated UE sensing data, and performs back propagation including identifying aggregated performance characteristics such as gradients 1418 to update weights of the model and improve beam blockage prediction performance. In the example of FIG. 10, the trainings or inferences conducted at the UEs and the ML service entity may be separated or de-coupled, as there is no exchange of gradients 1418 between the devices. Thus, in this separated environment, referring to FIGS. 11-12, the UE 1102 (e.g., the controller/processor 359 of UE 350, or the ML service at the UE) may determine to switch to one of its models 1202 independently of the gradients 1418 or other aggregated performance characteristics of the beam blockage prediction model. For example, if the UE is determining to switch (when adapting its sensing and extraction model at 8.4 of FIG. 11) to a high accuracy one of the models 1202 during model selection 1204, that high accuracy may result from updated model weights based on local gradients of the feature extraction model obtained by the UE, but not based on aggregated gradients 1418 of the beam blockage prediction model obtained by the ML service entity. Accordingly, the UE may determine to switch to this model due to its higher accuracy resulting independently of the aggregated gradients.

In contrast, in the example of FIG. 14, the ML service entity 1414 may broadcast aggregated, gradient information 1418 (or other aggregated back propagated output from the beam blockage prediction model 1416) to the UEs. Upon receiving these aggregated performance characteristics (e.g., by RX processor 356 of UE 350, or by the ML service of the UE), the UE may update the weights of their feature extraction models based not only on their local gradients but also the aggregated gradients 1418 received from the ML server or gNB. As a result, referring to FIGS. 12, 14, and 15, if the UE 1502 is determining to switch (when adapting its sensing and extraction model at 8.5 of FIG. 15) to a high accuracy one of the models 1202 during model selection 1204, that high accuracy here may result not only from updated model weights based on the local gradients of the feature extraction model obtained by the UE but also based on the aggregated gradients 1418 of the beam blockage prediction model obtained by the ML service entity. Accordingly, after receiving the aggregated gradients at 8.4 of FIG. 15, the UE (e.g., the controller/processor 359 of UE 350, or the ML service at the UE) may determine to switch to this model due to its higher accuracy resulting from the aggregated gradients.

At 1708, the UE may transmit, in response to the switch, the ML-based feature data for predicting the beam blockage based on the one of the ML-based feature data extraction models. For example, 1708 may be performed by feature data transmission component 1946. For instance, referring to FIGS. 9-16, the UE 104, 104a, 1102, 1502, 1602 (e.g., the TX processor 368 of UE 350, or the ML service of the UE) may transmit training data 902 to an ML service entity at an ML server or base station for training at the non-RT RIC, inference data 904 to the ML service entity for inferences at the near-RT RIC (e.g., training or inference data 1314, 1316), OBBs 1206, or other features 1006, 1012, 1406, 1412 to the ML service entity 1014, 1104, 1302, 1414, 1504, 1604, or to the base station or ML server interfacing with the ML service entity. This ML-based feature data, which may be transmitted at 8.6 of FIG. 11 or 15 for example, may be based on the model 1202 to which the UE determined to switch at 1704. For instance, the OBBs 1206 transmitted at 8.6 of FIG. 11 or 15 may be output from the new model following the model switching. Moreover, this ML-based feature data may be for beam blockage prediction, or the beam blockage prediction may be based on the new model to which the UE switched. For example, referring to FIG. 7, the OBBs 1206 transmitted at 8.6 of FIG. 11 or 16 from UE 704a may identify potential UEs or other objects (e.g., truck 711) which the ML service entity 749 may predict to cause LOS blockages of beams (e.g., beam 707). Similarly, the model switching may result in faster or more accurate OBBs 1206 from the UE 704a, which may in turn allow the ML service entity 749 to better identify potential causes of LOS beam blockages in the dynamic or mobile environment of the UE.

In one example, at 1710, the UE may transmit a confidence level associated with the ML-based feature data. For example, 1710 may be performed by confidence level transmission component 1948. For instance, referring to FIG. 11, when the UE 1102 (e.g., the TX processor 368 of UE 350, or the ML service of the UE) provides training or inference data to the ML service entity 1104 as previously described at 8.1 or 8.6, the UE may further include a confidence level indicating an accuracy associated with the data provided. For example, referring to FIG. 12, the confidence level may for example be a flag or bit indicating whether a respective one of the OBBs 1206 output from the model 1202 is accurately detected to bound an object or not. In another example, the model 1202 may infer the distribution curves for the dimensions of the OBB, and the confidence level may indicate the accuracy of an inferred dimension of the OBB based on the distribution curves. In another example, the model 1202 may infer bounding boxes along with their dimensions and directions, while allowing for a greater margin of error along dimensions and directions carrying the greatest measure of uncertainty, and the confidence level may indicate the margin of error of these dimensions or directions. In another example, the confidence level may reflect a combination of any one or more of these accuracy indicators mentioned above.

In one example, the determining at 1704 to switch to the one of the ML-based feature data extraction models may be based on a capability of the second one of the ML-based feature data extraction models to derive the confidence level. For example, referring to FIG. 11, the ML service entity 1104 may request the UE 1102 at 8.3 to switch to one of its multiple models 1202 of FIG. 12 which has a capability of inferring a confidence level for its OBBs 1206 or other extracted features. The confidence level may reflect a combination of any one or more of the accuracy indicators mentioned above at 1710. In response to receiving the request, at 8.4, the UE 1102 may determine to switch to one of its ML models 1202 which have the requested confidence level capability, and adapt its sensing and feature extraction accordingly as previously described. For example, the UE may switch to an ML model expressly indicated in the request as a result of its capability of inferring confidence levels, or if an express indication is not present, the UE may switch to a whichever ML model it deems appropriate (e.g., resulting in either faster OBBs or more accurate OBBs depending on UE state) so long as that model is also capable of inferring confidence levels for the OBBs.

In one example, the message at 1702 may further comprise instructions for the UE to reconfigure a sensor of the UE, and the ML-based feature data may be further based on the sensor. For example, referring to FIG. 16, the UE 1602 may include configurable sensors such as RADAR sensors, LIDAR sensors, or cameras including reconfigurable parameters such as, but not limited to, FoV, orientation range, resolution or image resolution, update rate or frame rate, and the like, and the ML service entity 1604 at the ML server or base station may manage the configuration or reconfiguration of these parameters of the UE's sensors. For instance, the UE 1602 may receive from the ML service entity 1604 either a sensor reconfiguration configuration/request at 7, which may indicate UE sensor parameters the gNB/ML server requests the UE to reconfigure, or a sensor reconfiguration response at 12, which may confirm UE sensor parameters the UE previously requested to be reconfigured (at 11). The sensor reconfiguration request at 7 of FIG. 16, or the sensor reconfiguration response at 12 of FIG. 16, may be combined in the configuration/request message received by the UE at 8.3 of FIG. 11. Alternatively, the requests may be received in different configuration messages. Moreover, with respect to FIG. 12, as a result of the sensor reconfiguration, the sensor data input into the models 1202 may change, resulting in different OBBs 1206.

In one variation of the example relating to sensor reconfiguration, the message may be received in response to a satisfied criteria for sensor reconfiguration. For example, referring to FIG. 16, the UE 1602 may receive the sensor reconfiguration request at 7 if the ML service entity 1604 determines that a certain criteria triggering the sensor reconfiguration request has been satisfied. The criteria may relate to, for example, service training requirements, ML service inference requirements, ML service performance requirements, network traffic load, and a number of UEs in the area. In one example, with respect to ML service training, the UE may have unobstructed or obstructed views. If the UE has unobstructed views, the gNB/ML server may configure the UE to combine all RADAR point clouds from its various sensors and transmit a joint feature map to the gNB/ML server. If the UE has obstructed views, for example, from its front RADAR that can complement the left window radar of an adjacent vehicle UE, the gNB/ML server may configure the UE to return the feature map from that front RADAR point cloud separately or perform some other complementary configuration. In another example, with respect to ML service inferences, the UE may have occlusions in a previously declared field of view. For example, if a UE which previously had a mostly unobstructed RADAR has an occlusion (or an approaching occlusion) to the RADAR, the gNB/ML server may instruct the UE to not use the obstructed RADAR and separately instruct an adjacent vehicle UE to start using its unobstructed RADAR. In a further example, with respect to ML performance requirements, performance degradation may occur of the beam blockage prediction model due to poor resolution of the data or high mobility of the UEs. Thus, the gNB/ML server may configure the UEs sensors to adapt accordingly to improve sensor resolution or account for UE mobility. In another example, if the gNB/ML server determines a high network traffic load, the gNB/ML server may configure the UE to lower its RADAR measurement update rate, or to lower the resolution and frame rate of its camera. In an additional example, if the number of UEs in the area of the UE is high, the gNB/ML server may configure the UE to similarly lower its RADAR measurement update rate.

In another variation of the example relating to sensor reconfiguration, at 1712, the UE may determine that a criteria for sensor reconfiguration is satisfied, and at 1714, the UE may reconfigure at least one of a FoV, a range, a measurement update rate, a resolution, or a frame rate of the sensor in response to the criteria being satisfied. For example, 1712 may be performed by criteria determination component 1950, and 1714 may be performed by sensor reconfiguration component 1952. For example, referring to FIG. 16, the UE 1602 (e.g., the controller/processor 359 of UE 350, or the ML service of the UE) may determine that a certain criteria has been satisfied which triggers the UE to send the sensor reconfiguration request to the ML service entity of the ML server or base station at 11. The criteria may relate to, for example, vehicle sensor settings and configurations, sensor availability, sensor selection, location changes, speed changes, direction changes, radio link quality with the gNB/ML server, a UE vehicle advanced driver-assistance system (ADAS), or UE sensor occlusion. In one example related to vehicle sensor settings and configurations, the UE may determine to change its FoV, range, or measurement update rate of its sensors in order to gain information of an area of interest. In another example related to sensor availability, upon determining that a sensor such as a rear RADAR is not actively used for an ADAS task, the UE may determine to reconfigure the sensor to serve the sensing need of the ML server/gNB. In another example related to sensor selections, the UE may determine to select one or more specific sensors, such as its front RADAR only or its front mounted camera only, based on the sensing needs of the ML server or gNB. In another example related to location changes, the UE may determine to change its FoV and range in response to determining that the UE is located on a highway or at an intersection. In another example related to speed changes, the UE may determine to change its measurement update rate or change its FoV in response to determining a speed up or a speed down. In another example related to direction changes, the UE may determine to use a different set of sensors for beam blockage prediction in response to determining a change in its direction. In another example related to radio link quality with the gNB/ML server, the UE may determine to change its data rate or latency associated with communicating its data to the gNB/ML server, for example, by lowering the RADAR measurement update rate or the resolution or frame rate of the camera when the connection is poor, while increasing the RADAR measurement update rate or the resolution or the frame rate of the camera when the connection is strong. In another example related to the UE's vehicle ADAS, the UE may determine to reconfigure, for example, the FoV of a RADAR which is previously configured to serve the gNB/ML server's training, inference, or ML performance optimization needs, in order to serve the vehicle's ADAS need, by preemptively overriding the previous setting of the FoV and sending the gNB/ML server a reconfiguration update message including its reconfigured parameters for its RADAR. In a further example related to UE sensor occlusion, the UE may determine to adapt its sensing due to occlusions in a previously declared FoV, for example, if the UE which previously had a mostly unobstructed RADAR has an occlusion (or approaching occlusion) to the RADAR, the UE can preemptively reconfigure the FoV or switch to another RADAR having an unobstructed view and send the gNB/ML server a reconfiguration update message including reconfigured parameters accordingly. In any one or more of these examples, following confirmation of the sensor reconfiguration request at 12, the UE (e.g., the controller/processor 359 of UE 350, or the ML service of the UE) may reconfigure its sensors at 13. For example, the UE may update its RADAR, LIDAR, or camera parameters such as previously described in the aforementioned examples.

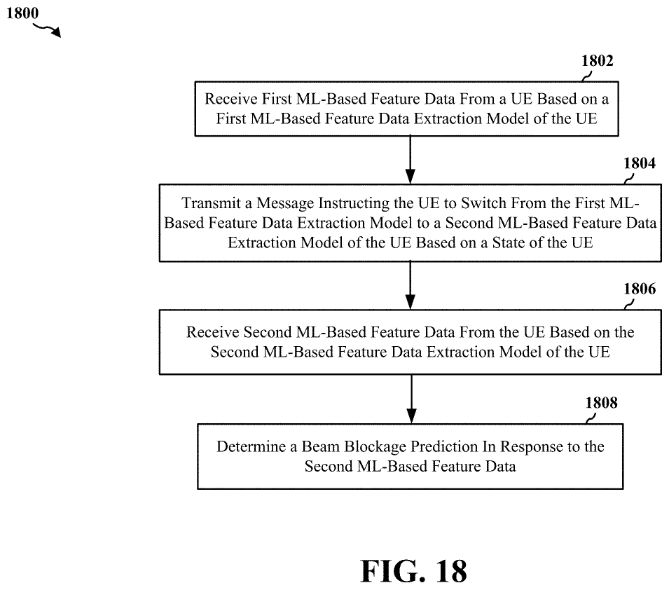

FIG. 18 is a flowchart 1800 of a method of wireless communication. The method may be performed by a network node. The network node may be, for example, an aggregated or disaggregated base station, an ML server co-located with or located near an aggregated or disaggregated base station (e.g., the base station 102/180, 310; the apparatus 2002), a component of a disaggregated base station (e.g., near-RT RIC 425, 525; non-RT RIC 415, 556; CU 410, 560, 561; DU 430, 562; RU 440, 564; or other disaggregated base station component), or the ML service entity 749, 830, 1014, 1104, 1302, 1414, 1504, 1604 in the aggregated base station, the component of a disaggregated base station, or the ML server co-located with or located near the base station. The method allows a network node to adaptively configure a UE to switch between its ML-based feature data extraction models (and optionally reconfigure its sensors) in order to provide feature data of dynamic or mobile potential LOS obstacles for improved beam blockage prediction performance at the network node.

At 1802, the network node may receive first ML-based feature data from a UE based on a first ML-based feature data extraction model of the UE. For example, 1802 may be performed by feature data reception component 2040. For instance, the base station, ML server, near-RT MC, non-RT MC, CU, DU, RU, or other network node may initially receive extracted features from the UE. For example, referring to FIGS. 9-16, at 8.1 of FIG. 11 or 8.2 of FIG. 15, the ML service entity 1014, 1104, 1302, 1414, 1504, 1604 (or the Rₓ processor 370 of the network node or base station 310 of FIG. 3) may receive, from the UE 104, 104a, 1102, 1502, 1602, training data 902 for training at the non-RT MC or inference data 904 for inferences at the near-RT MC (e.g., training or inference data 1314, 1316), OBBs 1206, or features 1006, 1012, 1406, 1412. Alternatively, the base station or ML server interfacing with the ML service entity, or a component of a disaggregated base station interfacing with the ML service entity, may receive this data. This ML-based feature data, which may be received by the ML service entity at 8.6 of FIG. 11 or 15 for example, may be based on one of the models 1202 for feature extraction available at the UE. For instance, the OBBs 1206 received at 8.1 of FIG. 11 or 8.2 of 15 may be output from the model 1202. Moreover, this ML-based feature data may be for beam blockage prediction, or the beam blockage prediction may be based on the model of the UE. For example, referring to FIG. 7, the OBBs 1206 received at 8.1 or 8.2 of FIG. 11 or 15 from UE 704a may identify potential UEs or other objects (e.g., truck 711) which the ML service entity 749 may predict to cause LOS blockages of beams (e.g., beam 707).

At 1804, the network node may transmit a message instructing the UE to switch from the first ML-based feature data extraction model to a second ML-based feature data extraction model of the UE based on a state of the UE. For example, 1804 may be performed by configuration transmission component 2042. For instance, referring to FIGS. 11 and 12, the ML service entity 1104 of the base station or ML server, the base station or ML server itself (e.g., the TX processor 316 of the network node or base station 310 of FIG. 3), or a component of a disaggregated base station (e.g., the CU, DU, RU, etc.), may transmit to the UE 1102, at 8.3, a request for the UE to switch from one of its models 1202 (referenced in 1802) to another one of its models 1202 for extracting OBBs 1206 or other feature data from point clouds, images, or other sensor data. The request may be transmitted based on a state of the UE, for example, a mobility status of the UE (e.g., a speed of the UE, a moving direction of the UE, or position of the UE relative to other UEs, pedestrians or buildings, and the like), a number of UEs in the UE's area or location, a computational or data processing capability of the UE, an amount of uplink traffic sharing the UE's bandwidth or the uplink traffic load of the network including the UE, and the like. For instance, if the UE has initially been applying one of its feature data extraction models at a particular UE speed, location, network traffic load, etc., but later the UE has increased its speed, changed its location, experienced an increase in uplink traffic, or some other UE state change has occurred, the request may indicate the UE to switch from that model to a different model which may output OBBs or other feature data at a faster rate albeit with a tradeoff to accuracy, in order for the ML service entity 1104 to more quickly predict beam blockages.

In one example, the network node may further include a plurality of ML models for beam management, and the message may be based on a performance of at least one of the ML models for beam management. For example, referring to FIGS. 11-13, the ML service entity 1104, 1302 may include beamforming model 1306 and beam-tracking model 1308. If the ML service entity 1104, 1302 determines, based on beam measurements collected by the base station or reported by end users, that the performance (prediction accuracy) of beamforming model 1306 or beam refinement model 1308 is unacceptably low or below a certain criteria, the ML service entity, the base station, ML server, component of the base station, or other network node may request (in the message/request at 8.3) the UE to switch to a different one of its models 1202 to provide slower or more accurate OBBs 1206 to the ML service entity. In turn, the ML service entity 1104 may input this more accurate sensing information in its models and more accurately predict beam blockages, best beams, and the like, resulting in better model performance.

In another example, the message may further comprise instructions for the UE to transmit different ML-based feature data for different ML models for beam management of the network node. For example, referring to FIGS. 11-13, if the ML service entity 1104 is currently applying the beamforming model 1306 to make beamforming predictions, the ML service entity, the base station, ML server, component of the base station, or other network node may request (in the configuration at 8.3) the UE 1102 to switch to one of its models 1202 in FIG. 12 and provide training or inference data 1314. The training or inference data 1314 may be, for example, OBBs indicating potential UEs in an area within the UE's sensor's field of view. Alternatively, if the ML service entity 1104 is currently applying the beam refinement model 1308 to make beam refinement predictions, the ML service entity, the base station, ML server, component of the base station, or other network node may request (in the configuration at 8.3) the UE 1102 to switch to a different one of its models 1202 in FIG. 12 and provide different training or inference data 1316 accordingly. The training or inference data 1316 may be, for example, OBBs indicating potential UEs with finer sensor resolution than that of training or inference data 1314, or even the same OBBs as in training or inference data 1314 but at a faster rate.

In one example, the first ML-based feature data extraction model and the second ML-based feature data extraction model may include different computation speeds and different detection accuracies. For example, some of the models 1202 may be more complex than other models (e.g., have longer computation timing, include different amounts of data collection, and the like), and some of the models 1202 may have different performance than other models (e.g., have less accuracy, more false alarms or misdetection of OBBs, and the like). The different complexity and performance of these models 1202 may be a result of different characteristics of these models as well. For instance, some of the models 1202 may be a standalone architectural framework such as MLP, CNN, or RNN, while others of the models 1202 may be a combination of the aforementioned architectural frameworks. Moreover, models 1202 may have different numbers of layers, kernel sizes, activation functions used in different layers, weights of different layers, and the like.

At 1806, the network node may receive second ML-based feature data from the UE based on the second ML-based feature data extraction model of the UE. For example, 1806 may be performed by feature data reception component 2040. For example, referring to FIGS. 9-16, at 8.6 of FIG. 11 or 15, the ML service entity 1014, 1104, 1302, 1414, 1504, 1604 (or the RX process 370 of the network node or base station 310) may receive, from the UE 104, 104a, 1102, 1502, 1602, training data 902 for training at the non-RT RIC or inference data 904 for inferences at the near-RT RIC (e.g., training or inference data 1314, 1316), OBBs 1206, or features 1006, 1012, 1406, 1412. Alternatively, the base station or ML server interfacing with the ML service entity, or a component of a disaggregated base station interfacing with the ML service entity, may receive this data. This ML-based feature data, which may be received by the ML service entity at 8.6 of FIG. 11 or 15 for example, may be based the new one of the models 1202 for feature extraction available at the UE to which the configuration at 1804 indicated the UE to switch. For instance, the OBBs 1206 received at 8.6 of FIG. 11 or 15 may be output from the new model 1202 following the model switching. Similarly, this ML-based feature data may be for beam blockage prediction, or the beam blockage prediction may be based on this new model of the UE. For example, referring to FIG. 7, the OBBs 1206 received at 8.6 of FIG. 11 or 15 from UE 704a may be faster or more accurate than those received at 8.1 of FIG. 11 or 8.2 of FIG. 15, and thus may better identify potential UEs or other objects (e.g., truck 711) which the ML service entity 749 may predict to cause LOS blockages of beams (e.g., beam 707).

At 1808, the network node may determine a beam blockage prediction in response to the second ML-based feature data. For example, 1808 may be performed by prediction determination component 2044. For example, referring to FIG. 8, the ML service entity 830 may include a beam blockage prediction model 1016, 1416 (e.g., neural network(s) 826) which predicts whether a beam blockage exists from the OBBs 1206 received at 8.6 of FIG. 11 or 15. For instance, the model may receive as input at least an aggregation of OBBs 811.1-811.N (including OBBs 1206 from the new model of the UE following a model switch), forward pass these inputs with model weights to one or more activation functions of the layer(s) of the neural network, and output a prediction in response to the forward pass. After obtaining the model prediction/output, the ML service entity at the ML server or base station may interpret the existence of a LOS beam blockage, and communicate this prediction to the ML server or the base station to perform beam management to address the LOS blockage. Thus, if the network node is the ML service entity, the network node may determine the beam blockage prediction by obtaining the model prediction/output from the model and/or interpreting the model prediction/output as a LOS beam blockage. Similarly, if the network node is an entity interfacing with the ML service entity, such as an aggregated or disaggregated base station, ML server collocated with or located near the base station, or a component of a disaggregated base station (e.g., the controller/processor 375 of the network node or base station 310, or the CU, DU, RU, etc.), then the network node may determine the beam blockage prediction by obtaining the communicated model prediction and/or interpreted LOS beam blockage from the ML service entity.

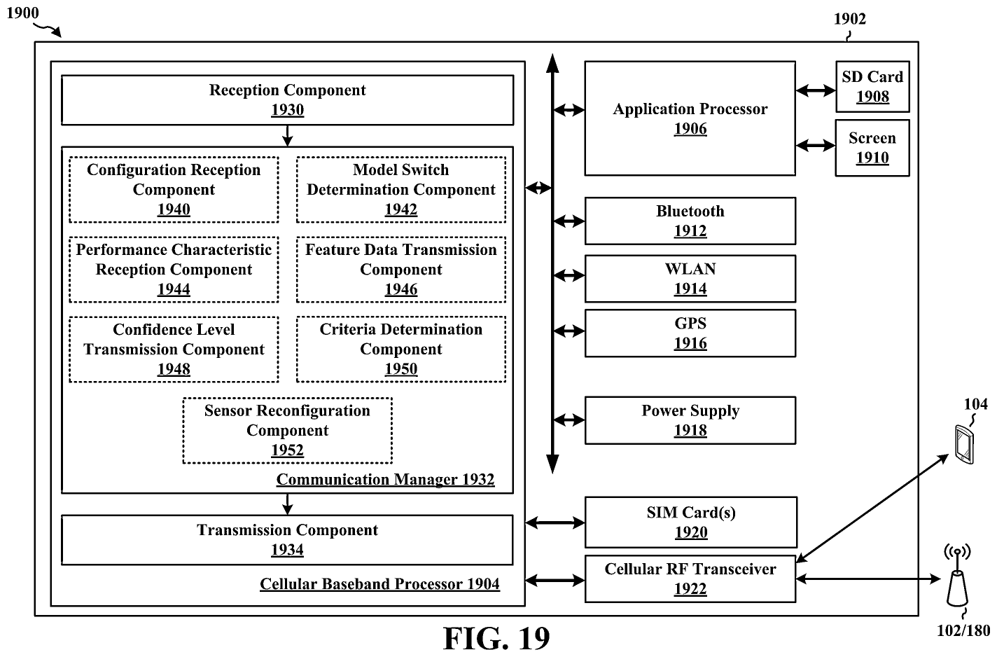

FIG. 19 is a diagram 1900 illustrating an example of a hardware implementation for an apparatus 1902. The apparatus 1902 is a UE and includes a cellular baseband processor 1904 (also referred to as a modem) coupled to a cellular RF transceiver 1922 and one or more subscriber identity modules (SIM) cards 1920, an application processor 1906 coupled to a secure digital (SD) card 1908 and a screen 1910, a Bluetooth module 1912, a wireless local area network (WLAN) module 1914, a Global Positioning System (GPS) module 1916, and a power supply 1918. The cellular baseband processor 1904 communicates through the cellular RF transceiver 1922 with the UE 104 and/or BS 102/180. The cellular baseband processor 1904 may include a computer-readable medium/memory. The computer-readable medium/memory may be non-transitory. The cellular baseband processor 1904 is responsible for general processing, including the execution of software stored on the computer-readable medium/memory. The software, when executed by the cellular baseband processor 1904, causes the cellular baseband processor 1904 to perform the various functions described supra. The computer-readable medium/memory may also be used for storing data that is manipulated by the cellular baseband processor 1904 when executing software. The cellular baseband processor 1904 further includes a reception component 1930, a communication manager 1932, and a transmission component 1934. The communication manager 1932 includes the one or more illustrated components. The components within the communication manager 1932 may be stored in the computer-readable medium/memory and/or configured as hardware within the cellular baseband processor 1904. The cellular baseband processor 1904 may be a component of the UE 350 and may include the memory 360 and/or at least one of the TX processor 368, the RX processor 356, and the controller/processor 359. In one configuration, the apparatus 1902 may be a modem chip and include just the baseband processor 1904, and in another configuration, the apparatus 1902 may be the entire UE (e.g., see 350 of FIG. 3) and include the aforediscussed additional modules of the apparatus 1902.

The communication manager 1932 includes a configuration reception component 1940 that is configured to receive a message instructing the apparatus to switch from a current machine learning (ML)-based feature data extraction model to one of a plurality of ML-based feature data extraction models of the apparatus based on a state of the apparatus, the plurality of ML-based feature data extraction models each providing ML-based feature data for predicting a beam blockage between the apparatus and a network entity, e.g., as described in connection with 1702. The message may be indicative of a performance of at least one of a plurality of ML models for beam management. The message may further comprise instructions for the apparatus to transmit different ML-based feature data for different ones of the ML models for beam management. The communication manager 1932 further includes a model switch determination component 1942 that receives input in the form of the message from the configuration reception component 1940 and is configured to determine to switch from the current ML-based feature data extraction model to the one of the ML-based feature data extraction models based at least in part on the message, e.g., as described in connection with 1704. The ML-based feature data extraction models may include different computation speeds and different detection accuracies. The communication manager 1932 further includes a feature data transmission component 1946 that receives input in the form of the one of the ML-based feature data extraction models from the model switch determination component 1942 and is configured to transmit, in response to the switch, the ML-based feature data for predicting the beam blockage based on the one of the ML-based feature data extraction models, e.g., as described in connection with 1708.

In one example, the model switch determination component 1942 may be further configured to determine to switch to the one of the ML-based feature data extraction models independently of an aggregated performance characteristic of an ML model for beam blockage prediction of the network node, where the ML model for beam blockage prediction includes an aggregate of input ML-based feature data from a plurality of UEs including the apparatus. In another example, the communication manager 1932 may further include a performance characteristic reception component 1944 that is configured to receive an aggregated performance characteristic of an ML model for beam blockage prediction, where the ML model for beam blockage prediction includes an aggregate of input ML-based feature data from a plurality of UEs including the apparatus, e.g., as described in connection with 1706. The model switch determination component 1942 in this other example may receive input in the form of the aggregated performance characteristic from the performance characteristic reception component 1944 and may be further configured to determine to switch to the one of the ML-based feature data extraction models further based on the aggregated performance characteristic.

The communication manager 1932 may further include a confidence level transmission component 1948 that receives input in the form of the ML-based feature data from the feature data transmission component 1946 and is configured to transmit a confidence level associated with the ML-based feature data, e.g., as described in connection with 1710. In one example, the model switch determination component 1942 may receive input in the form of the confidence level from the confidence level transmission component 1948 and may be further configured to determine to switch to the one of the ML-based feature data extraction models based on a capability of the one of the ML-based feature data extraction models to derive the confidence level.

The message received by the configuration reception component 1940 may further comprise instructions for the apparatus to reconfigure a sensor of the apparatus, and the ML-based feature data may be further based on the sensor. In one example, the message may be received in response to a satisfied criteria for sensor reconfiguration. In another example, the communication manager 1932 may further include a criteria determination component 1950 that is configured to determine that a criteria for sensor reconfiguration is satisfied, e.g., as described in connection with 1712, and the communication manager 1932 may further include a sensor reconfiguration component 1952 that may receive input in the form of the criteria determination from the criteria determination component 1950 and may be configured to reconfigure at least one of a FoV, a range, a measurement update rate, a resolution, or a frame rate of the sensor in response to the criteria being satisfied, e.g., as described in connection with 1714.

The apparatus may include additional components that perform each of the blocks of the algorithm in the aforementioned flowchart of FIG. 17. As such, each block in the aforementioned flowchart of FIG. 17 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1902, and in particular the cellular baseband processor 1904, includes means for receiving a message instructing the apparatus to switch from a current ML-based feature data extraction model to one of a plurality of ML-based feature data extraction models of the apparatus based on a state of the apparatus, the plurality of ML-based feature data extraction models each providing ML-based feature data for predicting a beam blockage between the apparatus and a network entity; means for determining to switch from the current ML-based feature data extraction model to the one of the ML-based feature data extraction models based at least in part on the message; and means for transmitting, in response to the switch, the ML-based feature data for predicting the beam blockage based on the one of the ML-based feature data extraction models.

In one configuration, the ML-based feature data extraction models may include different computation speeds and different detection accuracies.

In one configuration, the message may be indicative of a performance of at least one of a plurality of ML models for beam management. In one configuration, the message may further comprise instructions for the apparatus to transmit different ML-based feature data for different ones of the ML models for beam management.

In one configuration, the state of the apparatus may comprise at least one of: a mobility status of the apparatus, a number of UEs in an area of the apparatus, a data processing capability of the apparatus, an amount of uplink traffic sharing a bandwidth of the apparatus, or an uplink traffic load of a network including the apparatus.

In one configuration, the determining to switch to the second one of the ML-based feature data extraction models may be independent of an aggregated performance characteristic of an ML model for beam blockage prediction of the network node, the ML model for beam blockage prediction including an aggregate of input ML-based feature data from a plurality of UEs including the apparatus.

In one configuration, the means for receiving may be further configured to receive an aggregated performance characteristic of an ML model for beam blockage prediction, the ML model for beam blockage prediction including an aggregate of input ML-based feature data from a plurality of UEs including the apparatus, where the determining to switch to the one of the ML-based feature data extraction models is further based on the aggregated performance characteristic.

In one configuration, the means for transmitting may be further configured to transmit a confidence level associated with the ML-based feature data. In one configuration, the determining to switch to the one of the ML-based feature data extraction models may be based on a capability of the one of the ML-based feature data extraction models to derive the confidence level.

In one configuration, the message may further comprise instructions for the apparatus to reconfigure a sensor of the apparatus, and the ML-based feature data may be further based on the sensor. In one configuration, the configuration may be received in response to a satisfied criteria for sensor reconfiguration. In one configuration, the means for determining may be further configured to determine that a criteria for sensor reconfiguration is satisfied, and the apparatus 1902, and in particular the cellular baseband processor 1904, may include means for reconfiguring at least one of a FoV, a range, a measurement update rate, a resolution, or a frame rate of the sensor in response to the criteria being satisfied.

The aforementioned means may be one or more of the aforementioned components of the apparatus 1902 configured to perform the functions recited by the aforementioned means. As described supra, the apparatus 1902 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

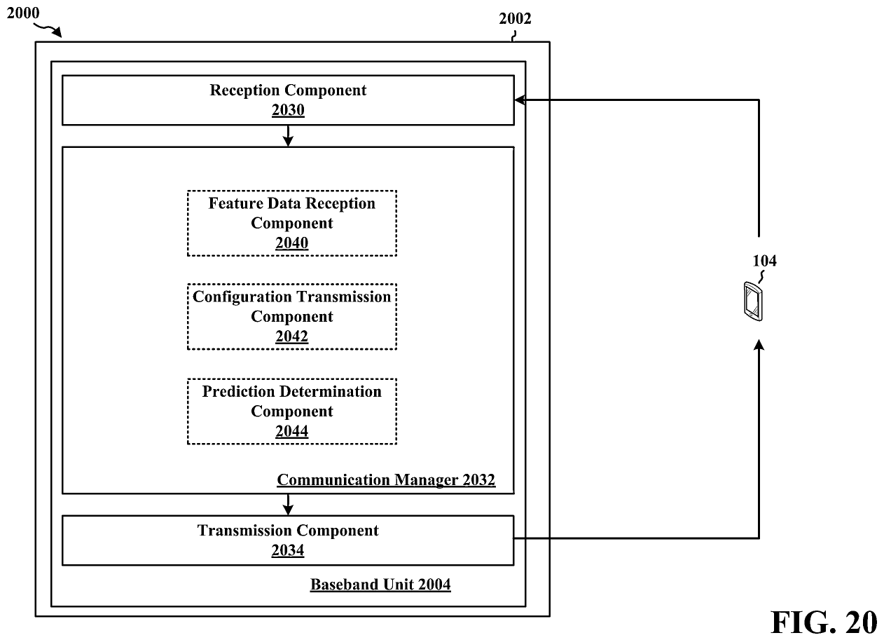

FIG. 20 is a diagram 2000 illustrating an example of a hardware implementation for an apparatus 2002. The apparatus 2002 is a BS and includes a baseband unit 2004. The baseband unit 2004 may communicate through a cellular RF transceiver with the UE 104. The baseband unit 2004 may include a computer-readable medium/memory. The baseband unit 2004 is responsible for general processing, including the execution of software stored on the computer-readable medium/memory. The software, when executed by the baseband unit 2004, causes the baseband unit 2004 to perform the various functions described supra. The computer-readable medium/memory may also be used for storing data that is manipulated by the baseband unit 2004 when executing software. The baseband unit 2004 further includes a reception component 2030, a communication manager 2032, and a transmission component 2034. The communication manager 2032 includes the one or more illustrated components. The components within the communication manager 2032 may be stored in the computer-readable medium/memory and/or configured as hardware within the baseband unit 2004. The baseband unit 2004 may be a component of the BS 310 and may include the memory 376 and/or at least one of the TX processor 316, the RX processor 370, and the controller/processor 375.

The communication manager 2032 includes a feature data reception component 2040 that is configured to receive first ML-based feature data from a UE based on a first ML-based feature data extraction model of the UE, e.g., as described in connection with 1802. The communication manager 2032 further includes a configuration transmission component 2042 that receives input in the form of the first ML-based feature data from the feature data reception component 2040 and is configured to transmit a message instructing the UE to switch from the first ML-based feature data extraction model to a second ML-based feature data extraction model of the UE based on a state of the UE, e.g., as described in connection with 1804. The network node may further include a plurality of ML models for beam management, and the message may be based on a performance of at least one of the ML models for beam management. Moreover, the message may comprise instructions for the UE to transmit different ML-based feature data for different ML models for beam management of the network node. The feature data reception component 2040 may be further configured to receive second ML-based feature data from the UE based on the second ML-based feature data extraction model of the UE, e.g., as described in connection with 1806. The communication manager 2032 further includes a prediction determination component 2044 that receives input in the form of the second ML-based feature data from the feature data reception component 2040 and is configured to determine a beam blockage prediction in response to the second ML-based feature data, e.g., as described in connection with 1808. The first ML-based feature data extraction model and the second ML-based feature data extraction model may include different computation speeds and different detection accuracies.

The apparatus may include additional components that perform each of the blocks of the algorithm in the aforementioned flowchart of FIG. 18. As such, each block in the aforementioned flowcharts of FIG. 18 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 2002, and in particular the baseband unit 2004, includes means for receiving first ML-based feature data from a UE based on a first ML-based feature data extraction model of the UE; means for transmitting a message instructing the UE to switch from the first ML-based feature data extraction model to a second ML-based feature data extraction model of the UE based on a state of the UE; where the means for receiving is further configured to receive second ML-based feature data from the UE based on the second ML-based feature data extraction model of the UE; and means for determining a beam blockage prediction in response to the second ML-based feature data.

In one configuration, the first ML-based feature data extraction model and the second ML-based feature data extraction model may include different computation speeds and different detection accuracies.

In one configuration, the network node may further include a plurality of ML models for beam management, and the message may be based on a performance of at least one of the ML models for beam management. In one configuration, the message may further comprise instructions for the UE to transmit different ML-based feature data for different ML models for beam management of the network node.

The aforementioned means may be one or more of the aforementioned components of the apparatus 2002 configured to perform the functions recited by the aforementioned means. As described supra, the apparatus 2002 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Accordingly, aspects of the present disclosure allow a network node to configure a UE to switch between UE feature data extraction models and optionally to reconfigure UE sensors in order to provide adaptive feature data of dynamic or mobile potential LOS obstacles for improved beam blockage prediction performance, beam management adaptation, scheduling, load balancing, or other functions at the network node. Some of the feature data extraction models may be more complex than other models (e.g., have longer computation timing, include different amounts of data collection, and the like), and some of the models may have different performance than other models (e.g., have less accuracy, more false alarms or misdetection of OBBs, and the like). As a result, depending on the state of the UE given the UE's existence in a mobile or dynamic environment, the network node may configure UEs to switch between different types of models (e.g., faster or more accurate models) in order to adaptively improve performance of its ML-based predictions of beam blockages or other inferences. The network node may also include multiple ML models serving different functions (such as beamforming or beam refinement), and the model switching may result in different feature data that the network node may respectively apply to improve performance of its different ML models. UEs may also provide confidence levels with associated feature data to assist the network node in determining the accuracy of received feature data, and the network node may further optimize its model performance by instructing UEs to switch to models capable of inferring such confidence levels or to switch to more accurate models if the confidence levels are below a given threshold. Trainings or inferences conducted at the UEs and the network node may also be separated or de-coupled for simplicity in implementation, or associated together in a joint system (i.e., through reporting of aggregated performance characteristics by the network node to the UE) for improved performance optimization of UE feature data extraction models based on feature data from other UEs.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Example 1 is an apparatus, comprising: a processor; memory coupled with the processor; and instructions stored in the memory and operable, when executed by the processor, to cause the apparatus to: receive a message instructing the apparatus to switch from a current machine learning (ML)-based feature data extraction model to one of a plurality of ML-based feature data extraction models of the apparatus based on a state of the apparatus, the plurality of ML-based feature data extraction models each providing ML-based feature data for predicting a beam blockage between the apparatus and a network entity; determine to switch from the current ML-based feature data extraction model to the one of the ML-based feature data extraction models based at least in part on the message; and transmit, in response to the switch, the ML-based feature data for predicting the beam blockage based on the one of the ML-based feature data extraction models.

Example 2 is the apparatus of Example 1, wherein the ML-based feature data extraction models include different computation speeds and different detection accuracies.

Example 3 is the apparatus of Examples 1 or 2, wherein the message is indicative of a performance of at least one of a plurality of ML models for beam management.

Example 4 is the apparatus of any of Examples 1 to 3, wherein the message further comprises instructions for the apparatus to transmit different ML-based feature data for different ML models for beam management.

Example 5 is the apparatus of any of Examples 1 to 4, wherein the state of the apparatus comprises at least one of: a mobility status of the apparatus, a number of user equipments (UEs) in an area of the apparatus, a data processing capability of the apparatus, an amount of uplink traffic sharing a bandwidth of the apparatus, or an uplink traffic load of a network including the apparatus.

Example 6 is the apparatus of any of Examples 1 to 5, wherein the instructions, when executed by the processor, further cause the apparatus to: receive an aggregated performance characteristic of an ML model for beam blockage prediction, the ML model for beam blockage prediction including an aggregate of input ML-based feature data from a plurality of UEs including the apparatus, wherein the determining to switch to the one of the ML-based feature data extraction models is further based on the aggregated performance characteristic.

Example 7 is the apparatus of any of Examples 1 to 6, wherein the instructions, when executed by the processor, further cause the apparatus to: transmit a confidence level associated with the ML-based feature data.

Example 8 is the apparatus of Example 7, wherein the determining to switch to the one of the ML-based feature data extraction models is based on a capability of the one of the ML-based feature data extraction models to derive the confidence level.

Example 9 is the apparatus of any of Examples 1 to 8, wherein the message further comprises instructions for the apparatus to reconfigure a sensor of the apparatus, and the ML-based feature data is further based on the sensor.

Example 10 is the apparatus of Example 9, wherein the message is received in response to a satisfied criteria for sensor reconfiguration.

Example 11 is the apparatus of Examples 9 or 10, wherein the instructions, when executed by the processor, further cause the apparatus to: determine that a criteria for sensor reconfiguration is satisfied; and reconfigure at least one of a field of view (FoV), a range, a measurement update rate, a resolution, or a frame rate of the sensor in response to the criteria being satisfied.

Example 12 a method of wireless communication at a user equipment (UE), comprising: receiving a message instructing the UE to switch from a current machine learning (ML)-based feature data extraction model to one of a plurality of ML-based feature data extraction models of the UE based on a state of the UE, the plurality of ML-based feature data extraction models each providing ML-based feature data for predicting a beam blockage between the UE and a network entity; determining to switch from the current ML-based feature data extraction model to the one of the ML-based feature data extraction models based at least in part on the message; and transmitting, in response to the switch, the ML-based feature data for predicting the beam blockage based on the one of the ML-based feature data extraction models.

Example 13 is the method of Example 12, wherein the ML-based feature data extraction models include different computation speeds and different detection accuracies.

Example 14 is the method of Examples 12 or 13, wherein the message is indicative of a performance of at least one of a plurality of ML models for beam management.

Example 15 is the method of any of Examples 12 to 14, wherein the message further comprises instructions for the UE to transmit different ML-based feature data for different ML models for beam management.

Example 16 is the method of any of Examples 12 to 15, wherein the state of the UE comprises at least one of: a mobility status of the UE, a number of UEs in an area of the UE, a data processing capability of the UE, an amount of uplink traffic sharing a bandwidth of the UE, or an uplink traffic load of a network including the UE.

Example 17 is the method of any of Examples 12 to 16, further comprising: receiving an aggregated performance characteristic of an ML model for beam blockage prediction, the ML model for beam blockage prediction including an aggregate of input ML-based feature data from a plurality of UEs including the UE, wherein the determining to switch to the one of the ML-based feature data extraction models is further based on the aggregated performance characteristic.

Example 18 is the method of any of Examples 12 to 17, further comprising: transmitting a confidence level associated with the ML-based feature data.

Example 19 is the method of Example 18, wherein the determining to switch to the one of the ML-based feature data extraction models is based on a capability of the one of the ML-based feature data extraction models to derive the confidence level.

Example 20 is the method of any of Examples 12 to 19, wherein the message further comprises instructions for the UE to reconfigure a sensor of the UE, and the ML-based feature data is further based on the sensor.

Example 21 is the method of Example 20, wherein the message is received in response to a satisfied criteria for sensor reconfiguration.

Example 22 is the method of Examples 20 or 21, further comprising: determining that a criteria for sensor reconfiguration is satisfied; and reconfiguring at least one of a field of view (FoV), a range, a measurement update rate, a resolution, or a frame rate of the sensor in response to the criteria being satisfied.

Example 23 is a network node, comprising: a processor; memory coupled with the processor; and instructions stored in the memory and operable, when executed by the processor, to cause the network node to: receive first machine learning (ML)-based feature data from a user equipment (UE) based on a first ML-based feature data extraction model of the UE; transmit a message instructing the UE to switch from the first ML-based feature data extraction model to a second ML-based feature data extraction model of the UE based on a state of the UE; receive second ML-based feature data from the UE based on the second ML-based feature data extraction model of the UE; and determine a beam blockage prediction in response to the second ML-based feature data.

Example 24 is the network node of Example 23, wherein the first ML-based feature data extraction model and the second ML-based feature data extraction model include different computation speeds and different detection accuracies.

Example 25 is the network node of Examples 23 or 24, wherein the network node further includes a plurality of ML models for beam management, and the message is based on a performance of at least one of the ML models for beam management.

Example 26 is the network node of any of Examples 23 to 25, wherein the message further comprises instructions for the UE to transmit different ML-based feature data for different ML models for beam management of the network node.

Example 27 is a method of wireless communication at a network node, comprising: receiving first machine learning (ML)-based feature data from a user equipment (UE) based on a first ML-based feature data extraction model of the UE; transmitting a message instructing the UE to switch from the first ML-based feature data extraction model to a second ML-based feature data extraction model of the UE based on a state of the UE; receiving second ML-based feature data from the UE based on the second ML-based feature data extraction model of the UE; and determining a beam blockage prediction in response to the second ML-based feature data.

Example 28 is the method of Example 27, wherein the first ML-based feature data extraction model and the second ML-based feature data extraction model include different computation speeds and different detection accuracies.

Example 29 is the method of Examples 27 or 28, wherein the network node further includes a plurality of ML models for beam management, and the message is based on a performance of at least one of the ML models for beam management.

Example 30 is the method of Example 29, wherein the message further comprises instructions for the UE to transmit different ML-based feature data for different ML models for beam management of the network node.

What is claimed is:

1. An apparatus, comprising:
a processor;
memory coupled with the processor; and
instructions stored in the memory and operable, when executed by the processor, to cause the apparatus to:
receive a message instructing the apparatus to switch from a current machine learning (ML)-based feature data extraction model to one of a plurality of ML-based feature data extraction models of the apparatus based on a state of the apparatus, the plurality of ML-based feature data extraction models each providing ML-based feature data for predicting a beam blockage between the apparatus and a network entity;
determine to switch from the current ML-based feature data extraction model to the one of the ML-based feature data extraction models based at least in part on the message; and
transmit, in response to the switch, the ML-based feature data for predicting the beam blockage based on the one of the ML-based feature data extraction models.

2. The apparatus of claim 1, wherein the plurality of ML-based feature data extraction models include different computation speeds and different detection accuracies.

3. The apparatus of claim 1, wherein the message is indicative of a performance of at least one of a plurality of ML models for beam management.

4. The apparatus of claim 1, wherein the message further comprises instructions for the apparatus to transmit different ML-based feature data for different ML models for beam management.

5. The apparatus of claim 1, wherein the state of the apparatus comprises at least one of:
a mobility status of the apparatus,
a number of user equipments (UEs) in an area of the apparatus,
a data processing capability of the apparatus,
an amount of uplink traffic sharing a bandwidth of the apparatus, or
an uplink traffic load of a network including the apparatus.

6. The apparatus of claim 1, wherein the instructions, when executed by the processor, further cause the apparatus to:
receive an aggregated performance characteristic of an ML model for beam blockage prediction, the ML model for beam blockage prediction including an aggregate of input ML-based feature data from a plurality of UEs including the apparatus, wherein the determining to switch to the one of the ML-based feature data extraction models is further based on the aggregated performance characteristic.

7. The apparatus of claim 1, wherein the instructions, when executed by the processor, further cause the apparatus to:
transmit a confidence level associated with the ML-based feature data.

8. The apparatus of claim 7, wherein the determining to switch to the one of the ML-based feature data extraction models is based on a capability of the one of the ML-based feature data extraction models to derive the confidence level.

9. The apparatus of claim 1, wherein the message further comprises instructions for the apparatus to reconfigure a sensor of the apparatus, and the ML-based feature data is further based on the sensor.

10. The apparatus of claim 9, wherein the message is received in response to a satisfied criteria for sensor reconfiguration.

11. The apparatus of claim 9, wherein the instructions, when executed by the processor, further cause the apparatus to:
determine that a criteria for sensor reconfiguration is satisfied; and
reconfigure at least one of a field of view (FoV), a range, a measurement update rate, a resolution, or a frame rate of the sensor in response to the criteria being satisfied.

12. An method of wireless communication at a user equipment (UE), comprising:
receiving a message instructing the UE to switch from a current machine learning (ML)-based feature data extraction model to one of a plurality of ML-based feature data extraction models of the UE based on a state of the UE, the plurality of ML-based feature data extraction models each providing ML-based feature data for predicting a beam blockage between the UE and a network entity;
determining to switch from the current ML-based feature data extraction model to the one of the ML-based feature data extraction models based at least in part on the message; and
transmitting, in response to the switch, the ML-based feature data for predicting the beam blockage based on the one of the ML-based feature data extraction models.

13. The method of claim 12, wherein the plurality of ML-based feature data extraction models include different computation speeds and different detection accuracies.

14. The method of claim 12, wherein the message is indicative of a performance of at least one of a plurality of ML models for beam management.

15. The method of claim 12, wherein the message further comprises instructions for the UE to transmit different ML-based feature data for different ML models for beam management.

16. The method of claim 12, wherein the state of the UE comprises at least one of:
a mobility status of the UE,
a number of UEs in an area of the UE,
a data processing capability of the UE,
an amount of uplink traffic sharing a bandwidth of the UE, or
an uplink traffic load of a network including the UE.

17. The method of claim 12, further comprising:
receiving an aggregated performance characteristic of an ML model for beam blockage prediction, the ML model for beam blockage prediction including an aggregate of input ML-based feature data from a plurality of UEs including the UE, wherein the determining to switch to the one of the ML-based feature data extraction models is further based on the aggregated performance characteristic.

18. The method of claim 12, further comprising:
transmitting a confidence level associated with the ML-based feature data.

19. The method of claim 18, wherein the determining to switch to the one of the ML-based feature data extraction models is based on a capability of the one of the ML-based feature data extraction models to derive the confidence level.

20. The method of claim 12, wherein the message further comprises instructions for the UE to reconfigure a sensor of the UE, and the ML-based feature data is further based on the sensor.

21. The method of claim 20, wherein the message is received in response to a satisfied criteria for sensor reconfiguration.

22. The method of claim 20, further comprising:
determining that a criteria for sensor reconfiguration is satisfied; and
reconfiguring at least one of a field of view (FoV), a range, a measurement update rate, a resolution, or a frame rate of the sensor in response to the criteria being satisfied.

23. A network node, comprising:
a processor;
memory coupled with the processor; and
instructions stored in the memory and operable, when executed by the processor, to cause the network node to:
receive first machine learning (ML)-based feature data from a user equipment (UE) based on a first ML-based feature data extraction model of the UE;
transmit a message instructing the UE to switch from the first ML-based feature data extraction model to a second ML-based feature data extraction model of the UE based on a state of the UE;
receive second ML-based feature data from the UE based on the second ML-based feature data extraction model of the UE; and
determine a beam blockage prediction in response to the second ML-based feature data.

24. The network node of claim 23, wherein the first ML-based feature data extraction model and the second ML-based feature data extraction model include different computation speeds and different detection accuracies.

25. The network node of claim 23, wherein the network node further includes a plurality of ML models for beam management, and the message is based on a performance of at least one of the ML models for beam management.

26. The network node of claim 23, wherein the message further comprises instructions for the UE to transmit different ML-based feature data for different ML models for beam management of the network node.

27. A method of wireless communication at a network node, comprising:
receiving first machine learning (ML)-based feature data from a user equipment (UE) based on a first ML-based feature data extraction model of the UE;
transmitting a message instructing the UE to switch from the first ML-based feature data extraction model to a second ML-based feature data extraction model of the UE based on a state of the UE;
receiving second ML-based feature data from the UE based on the second ML-based feature data extraction model of the UE; and
determining a beam blockage prediction in response to the second ML-based feature data.

28. The method of claim 27, wherein the first ML-based feature data extraction model and the second ML-based feature data extraction model include different computation speeds and different detection accuracies.

29. The method of claim 27, wherein the network node further includes a plurality of ML models for beam management, and the message is based on a performance of at least one of the ML models for beam management.

30. The method of claim 29, wherein the message further comprises instructions for the UE to transmit different ML-based feature data for different ML models for beam management of the network node.
